(19) United States
(12) Patent Application Publication
(10) Pub. No.: US 2025/0306054 A1
(43) Pub. Date: Oct. 2, 2025

(54) PIPETTING HEAD FOR A LIQUID DISPENSING APPARATUS

(71) Applicant: SPT LABTECH LTD., Hertfordshire (GB)

(72) Inventors: David GLEDHILL, Cambridgeshire (GB); Reuben PARDOE, Cambridgeshire (GB); Robert LEWIS, Cambridgeshire (GB); David COCHRANE, Bedfordshire (GB)

(21) Appl. No.: 18/864,650

(22) PCT Filed: May 25, 2023
(86) PCT No.: PCT/GB2023/051368

§ 371 Date: Nov. 11, 2024

(30) Foreign Application Priority Data
May 25, 2022 (GB) 2206322.6

(51) Int. Cl. G01N 35/10; B01L 3/00

(52) U.S. Cl. CPC G01N 35/1072; B01L 3/5085; G01N 35/1011; B01L 2400/0478; G01N 2035/103

(57) ABSTRACT

A pipetting head (100) for a liquid dispensing apparatus (10) for use with an array of removable pipettes (1010) is provided. The pipetting head has a pipette body mounting assembly (120) for holding the pipette bodies (1100) of the removable pipettes. a plunger mounting assembly (140) for holding the plungers (1200) of the removable pipettes, and a dispense drive actuator assembly (160) with a dispense drive mechanism (162) for moving the plunger mounting assembly along a drive axis. The pipetting head also includes a pipette body clamping mechanism (130) having a clamp drive mechanism (133) which includes a linear actuator (133) and a clamp drive linkage having at least one standoff (135) fixed to a clamping plate (125) and extending axially between the clamping plate and the actuator. The actuator moves the at least one standoff axially to selectively engage the pipette body clamping mechanism.

### FIELD OF THE INVENTION

The present invention relates to a pipetting head for a liquid dispensing apparatus for use with an array of pipettes, each having a pipette body, or “pipette tip”, and a plunger disposed within the pipette body. The present invention relates in particular to a pipetting head having a pipette body mounting assembly for holding the pipette bodies, a plunger mounting assembly for holding the plungers, a pipette body clamping mechanism by which the pipette bodies can be securely retained, and a dispense drive mechanism than drives relative motion between the plunger and pipette body mounting assemblies.

### BACKGROUND OF THE INVENTION

It is known to use a pipette to aspirate or dispense a liquid sample.

It is also known to use a pipette having a plunger disposed in a pipette body. A typical pipette, known as a “positive displacement” pipette, uses a plunger or piston to aspirate or dispense liquid either through direct contact with the sample liquid or via a small air gap. During use, the pipette body and plunger are mounted together on a pipetting head of a liquid dispensing apparatus, which drives the plunger relative to the body to aspirate or dispense liquid from an aperture at the distal end of the pipette body. Such pipettes can be used in automated machines to improve accuracy and repeatability of pipetting actions. Once the pipetting actions have been completed, the pipette body and plunger of the removable pipettes can be disconnected from the pipetting head and replaced.

The inventors have identified several problems with the manner in which pipettes are connected with known pipetting heads for liquid dispensing apparatuses.

There is a need for an improved pipetting head.

### SUMMARY OF THE INVENTION

A first aspect of the invention provides a pipetting head for a liquid dispensing apparatus for use with an array of pipettes, each having a pipette body and a plunger disposed within the pipette body, the pipetting head comprising: a pipetting head chassis; a pipette body mounting assembly for holding the pipette bodies; a plunger mounting assembly for holding the plungers; a dispense drive actuator assembly operable to move the plunger mounting assembly relative to the pipette body mounting assembly along a drive axis to perform a dispensing or aspirating operation, the dispense drive actuator assembly comprising a dispense drive motor and a dispense drive mechanism by which the dispense drive motor is coupled to the plunger mounting assembly to drive axial displacement thereof; and a pipette body clamping mechanism operable to selectively clamp the pipette bodies of the array of pipettes to the pipette body mounting assembly, the pipette body clamping mechanism comprising: a pipette body clamping plate positioned below the plunger mounting assembly; a plurality of pipette body clamping members on the pipette body clamping plate; and a pipette body clamp drive mechanism operable to selectively engage the pipette body clamping mechanism, the pipette body clamp drive mechanism having a linear actuator and a pipette body clamp drive linkage by which the linear actuator is coupled to the pipette body clamping plate, wherein the pipette body clamp drive linkage comprises at least one standoff fixed in relation to the pipette body clamping plate and extending axially between the pipette body clamping plate and the linear actuator, and wherein the linear actuator is configured to move the at least one standoff relative to the pipetting head chassis in the axial direction to selectively engage the pipette body clamping mechanism.

With this arrangement, the linear actuator of the pipette body clamping mechanism can be positioned remote from the pipette body clamping plate and out of the way of other moving parts of the pipetting head. This can improve the packaging of components within the pipetting head. This is in contrast with arrangements in which the pipette body clamps are operated by a motor which is fixed at the side of the pipette body clamping plate. The claimed arrangement can allow the width of the pipetting head to be reduced and avoid interference between the actuator and components or equipment placed on the deck beneath the pipetting head. Additionally, by providing at least one standoff between the linear actuator and the pipette body clamping plate, this arrangement allows the rotational drive for the pipette body clamping plate to be separated from the means by which the pipette body clamping plate is guided or moved. This has been found to reduce the risk of plate misalignment, or “crabbing” relative to arrangements in which the rotational drive and guiding is provided by the same components, for example arrangements in which pulley nuts connected to the clamping plate are rotated to move the plate along threaded rods.

The pipetting head is configured for use with an array of pipettes each having a pipette body and a plunger disposed within the pipette body. The array of pipettes is an array of removable pipettes, each having a removable pipette body and a removable plunger. Thus, the plunger mounting assembly is for holding the removable plungers of the array of removable pipettes. This contrasts with some known pipetting heads in which the plungers or “pistons” remain secured to the pipetting head and the removable pipettes consist only of a removable pipette tip. The use of pipettes with removable plungers can help to reduce the risk of cross contamination of samples. With the present invention, the plungers and the bodies or “tips” of the removable pipettes can be removed and replaced quickly in a single operation or in a small number of operations.

The pipette body mounting assembly is configured to hold, i.e. connect to and retain, the pipette bodies in relation to the pipetting head. The pipette body mounting assembly may be configured to hold a pipette body connector portion of the pipette body of each of the array of removable pipettes.

The plunger mounting assembly is configured to hold, i.e. connect to and retain, the plungers in relation to the pipetting head. The plunger mounting assembly may be configured to hold a plunger connector portion of the plunger of each of the array of removable pipettes.

As used herein, the terms “clamping” and “clamp” refer to arrangements by which the pipette body or plunger (or both) are mounted and locked in place to prevent inadvertent removal. This is in contrast to arrangements in which the pipette body or plunger are mounted without locking, for example using only an interference fit or a snap-fit connection in which the pipette body or plunger can be removed simply by pulling in an axial direction. The use of a clamping mechanism can also improve the accuracy of aspirating and dispensing operations by preventing small relative movements that might otherwise occur between the pipetting head and the plunger or the pipette body.

As used herein, the term “standoff” refers to a spacer or other rigid component which is used to separate two parts in an assembly. The at least one standoff maintains a spacing or separation between the pipette body clamping plate and the linear actuator and transfers axial drive to the pipette body clamping plate. The at least one standoff may comprise a single standoff. Preferably, the at least one standoff comprises a plurality of standoffs. The standoffs may be connected to a central region of the pipette body clamping plate. Preferably, the plurality of standoffs are connected to a periphery of the pipette body clamping plate. The plurality of standoffs may comprise two, three or more standoffs. The plurality of standoffs may be positioned symmetrically around the periphery of the pipette body clamping plate. The plurality of standoffs may comprise four standoffs. The four standoffs may each be connected to a corner of the pipette body clamping plate.

The at least one standoff may have any suitable shape. The at least one standoff may comprise at least one guide rod along which the plunger mounting assembly is slidably supported when axially displaced by the dispense drive actuator assembly.

The at least one guide rod may comprise a plurality of guide rods along which the plunger mounting assembly is slidably supported when axially displaced by the dispense drive actuator assembly. The plurality of standoffs may be a plurality of guide rods along which the plunger mounting assembly is slidably supported when axially displaced by the dispense drive actuator assembly.

With this arrangement, the at least one guide rod performs the dual function of transferring axial drive to the plurality of pipette body clamping members and providing a guide along which the plunger mounting assembly is slidably supported. Consequently, it is not necessary to provide separate components both to guide the movement of the plunger mounting assembly and to transfer axial drive to the plurality of clamping members. This frees up space within the pipetting head, allowing larger diameter guide rods to be used without increasing the size of pipetting head. This can further improve performance of the pipetting head by reducing the amount of flex in the guide rods and thereby maintaining a parallel relationship between the moving plates. For example, the guide rods may each have a diameter of between 8 mm and 14 mm, e.g. 10 mm or 12 mm. Further, by providing a single set of components both to guide the movement of the plunger mounting assembly and to transfer axial drive to the pipette body clamping members, there is less of a tolerance stack up between the various moving components of the pipetting head. This can improve the ease with which the pipetting head is operated and reduce the risk of misalignment. The plurality of guide rods may comprise two, three, four or more guide rods. The plurality of guide rods may comprise four standoffs, each connected to a corner of the pipette body clamping plate.

In certain preferred embodiments, the at least one standoff is slidably supported by the pipetting head chassis. This can further improve the rigidity of the moving components and reduce the risk of misalignment. The pipetting head chassis may comprise one or more linear bearings or bushes by which the at least one standoff is slidably supported by the pipetting head chassis. The pipetting head chassis may comprise a plurality of linear bearings or bushes by which the at least one standoff is slidably supported by the pipetting head chassis. The plurality of linear bearings may be spaced apart in the axial direction to slidably support the at least one standoff at multiple points along its length.

In certain preferred embodiments, the linear actuator is located above the plunger mounting assembly. This can further improve the extent to which the linear actuator is out of the way of the other moving components within the pipetting head. In such embodiments, the at least one standoff extends axially from beneath the plunger mounting assembly to above the plunger mounting assembly.

The linear actuator may comprise any suitable actuator. For example, the linear actuator may comprise a solenoid or a pneumatic or hydraulic actuation mechanism. In certain preferred embodiments, the linear actuator comprises a pipette body clamp motor and a screw mechanism for converting rotational movement of the pipette body clamp motor into axial movement of the at least one standoff.

The screw mechanism may be laterally offset from the dispense drive mechanism. In such examples, the axial force provided by the screw mechanism to the at least one standoff is laterally offset from the dispense drive mechanism. In certain preferred embodiments, the screw mechanism is hollow and defines an axial bore through which the dispense drive mechanism extends.

By co-locating the dispense drive mechanism and the screw mechanism of the pipette body clamp drive mechanism, this arrangement can provide a compact structure. The linear actuator and the dispense drive mechanism can both be located in-board of the plunger mounting assembly, i.e. do not extend in a lateral direction beyond the edges of the plunger mounting assembly. This is in contrast to known mechanisms which utilise a drive belt and pulleys which are located around the outer edges of the pipette and plunger mounting mechanisms. In such “outboard” mechanisms, the size of the pipetting head generally must be increased to accommodate the pulleys. The provision of such a compact pipette body clamp drive mechanism can more easily enable a large number of pipettes to be accurately and securely mounted to the pipetting head. This is of particular benefit in liquid dispensing apparatuses intended for use with standard 384 well plates, since the compact arrangement can be configured to hold 384 pipettes, for example in a 16×24 matrix. This enables liquid to be aspirated from or dispensed into a conventional 384 well plate in a single action.

The dispense drive mechanism may extend through the axial bore at a lateral offset to the axis of the screw mechanism. In certain preferred embodiments, the dispense drive mechanism and the screw mechanism are concentric. As used herein, the term “concentric” means that the dispense drive mechanism and the screw mechanism are both aligned along a common axis and have a common centre in a perpendicular plane along at least part of the length of the dispense drive mechanism. In other words, the dispense drive mechanism extends along a first axis and the screw mechanism is configured to rotate about a second axis, wherein the first and second axes are coaxial.

By arranging the dispense drive mechanism and the screw mechanism such that they are concentric, the dispense drive mechanism and the screw mechanism act along the same single axis. This ensures alignment of the forces applied by dispense drive mechanism and the pipette body clamping mechanism and can further help to keep a parallel relationship between the moveable parts of the pipetting head, to further promote smooth operation and reduce the risk of misalignment or crabbing from the uneven application of force across the width of the plunger mounting assembly and/or the pipette body clamping mechanism.

This arrangement also allows the screw mechanism to be provide a single force to the at least one standoff. This is in contrast to arrangements in which the pipette body clamping plate is moved along a plurality of threaded rods using a belt drive and pulleys, and in which the pulleys must be synchronised to ensure correct alignment. The arrangement allows the screw mechanism to be located centrally within the pipetting head so that the single force applied to the at least one standoff is applied centrally. This can further improve ease of operation and further reduce the risk of misalignment of the pipette body clamping plate.

In certain preferred embodiments, the screw mechanism comprises a first and second sleeves which are concentric. The first and second sleeves may be coupled by a threaded connection. The second sleeve may be fixed in relation to the at least one standoff. The pipette body clamp motor may be configured to rotate the first sleeve about the second sleeve to drive relative axial movement between the first and second sleeves with the threaded connection and thereby drive axial movement of the at least one standoff.

One of the first and second sleeves may be defined by an aperture in a plate. One or both of the first and second sleeves may be defined by a hollow shaft. Preferably, the first and second sleeves are defined by first and second hollow shafts.

Preferably, the threaded connection has a pitch diameter of less than 40 percent of the width of the plunger mounting assembly, preferably less than 30 percent, less than 20 percent, less than 10 percent, or less than 5 percent of the width of the plunger mounting assembly. For example, the threaded connection may have a pitch diameter of from 10 mm to 80 mm, from 20 mm to 60 mm, or from 30 mm to 50 mm.

In certain preferred embodiments, the pipette body clamp motor is coupled to the screw mechanism by one or more gears. The screw mechanism may be coupled to a ring gear configured for rotation by the pipette body clamp motor. In other examples, the pipette body clamp motor may be coupled to the screw mechanism by any suitable means, for example by a toothed belt drive or by a worm drive.

In certain preferred embodiments, the pipette body clamp motor is fixed in relation to the pipetting head chassis. The pipette body clamp motor may be fixed to the pipetting head chassis. The pipetting head chassis may comprise an upper head chassis part to which the pipette body clamp motor is attached. The pipette body clamp motor may be positioned adjacent to the dispense drive motor. This arrangement has been found to provide a particularly compact arrangement within the pipetting head.

The pipette body mounting assembly is configured to hold the pipette bodies in position relative to the pipetting head. The pipette body clamping mechanism is configured to securely clamp any pipette bodies present to the pipette body mounting assembly. The pipette body clamping mechanism functions separately to the pipette body mounting assembly. The pipette body mounting assembly holds the pipette bodies, while the pipette body clamping mechanism ensures firm fixing of the pipette bodies to the pipette body mounting assembly. This contrasts with arrangements in which the pipette bodies are held in place by a single mechanism. For example, arrangements in which the pipette bodies are arrayed in a magazine which is held in place against the underside of the pipetting head by a single mechanism. In such arrangements, such mechanisms could be regarded as a mounting assembly by which the pipette bodies are held in relation to the pipetting head. However, such arrangements do not have a clamping mechanism operable to selectively clamp the pipette bodies to the pipette body mounting assembly.

The pipette body mounting assembly may comprise a pipette body mounting plate having a plurality of pipette body mounts each configured to couple with one of the pipette bodies during use. The pipette body mounting plate may be defined by a lower surface of the pipetting head chassis. The pipette body clamping mechanism comprises a pipette body clamping plate on which the plurality of pipette body clamping members is provided, each pipette body clamping member being associated with one of the plurality of pipette body mounts.

The pipette body clamping plate is positioned below the pipette body mounting assembly. The pipette body clamping plate may be the lowest plate in the pipetting head. As used herein, the terms “above”, “upper”, “low”, “below”, and “lowest” refer to the normal orientation of the pipetting head during use. The plurality of pipette body clamping members may comprise a plurality of sleeves which define a clamping region. The plurality of pipette body clamping members may be co-axial with a plurality of pipette body mounts provided on the pipette body mounting assembly. The plurality of pipette body clamping members may circumscribe the plurality of pipette body mounts when the pipette body clamping mechanism is engaged. The plurality of sleeves may be defined by one or more discrete components secured to the pipette body clamping plate. In certain preferred embodiments, the plurality of sleeves are defined by apertures in the pipette body clamping plate itself. Each of the plurality of pipette body mounts may comprise a radially extending feature on its outer surface which is configured to form one half of a snap-fit connection. The clamping region of each of the plurality of sleeves may be axially adjacent to the radially extending feature on the outer surface of its associated pipette body mount when the pipette body clamping mechanism is in the clamp position. The clamping region of each of the plurality of sleeves may be axially offset from the radially extending feature on the outer surface of its associated pipette body mount when the pipette body clamping mechanism is in the release position.

The dispense drive actuator assembly may be a direct drive actuator assembly. In such embodiments, the dispense drive mechanism is a direct drive mechanism. As used herein, the term “direct drive mechanism” refers to a drive mechanism by which the dispense drive motor is either coupled directly to the plunger mounting assembly, or is coupled to the plunger mounting assembly via a rotationally rigid coupling. Throughout the description, the term “direct drive actuator” is used to refer to both a directly coupled arrangement and an arrangement in which the motor is coupled to the plunger mount assembly via a rotationally rigid coupling. The use of a direct drive actuator minimises the rotational play between the plunger mount assembly and the motor. This enables movement of the plunger mount assembly to be started and stopped quickly and accurately. This is in contrast to indirect drive mechanisms in which the motor is coupled to the plunger mount assembly via one or more belts or chains. In a similar manner, the clamp drive mechanism directly couples the clamp motor to the plurality of clamping members, enabling the movement of the pipette clamping mechanism to be started and stopped quickly and accurately.

The dispense drive motor may be a linear actuator configured to provide a translational input to the dispense drive mechanism. Preferably, the dispense drive motor is a rotary motor configured to provide a rotational input to the dispense drive mechanism and the dispense drive mechanism is configured to convert the rotational input into axial movement of the plunger mounting assembly.

The dispense drive mechanism may comprise a ball screw by which the drive motor is coupled to the plunger mounting assembly to drive movement of the plunger mount assembly in the axial direction. The dispense drive mechanism preferably comprises a drive shaft extending along the drive axis and a ball screw by which the drive shaft is coupled to the plunger mount assembly.

The direct drive arrangement, for example via a ball screw, has been found to offer higher levels of acceleration/deceleration of heavy loads than a belt driven system, thus enabling non-contact dispensing of low volume liquid samples. Furthermore, a direct drive arrangement offers higher positional accuracy and repeatability than an equivalent belt drive mechanism. This can have a significant impact on dispense performance.

The drive actuator is operated entirely independently of the pipette body clamping mechanism. By providing an independently operated drive actuator for dispensing or aspirating operations, a greater variety of plunger speeds can be achieved, enabling the pipetting head to be operated precisely in both a contact dispensing mode and in a non-contact dispensing mode. This is in contrast with some known liquid handling devices in which the pipette bodies and plungers are coupled to plates which are positioned along a common set of threaded rods and may only be moved relatively slowly relative to each other along the common rods. Non-contact dispensing is also known as jetting and is characterised in that liquid is dispensed from the pipette at a distance from the target so that the drop separates from the tip of the pipette body before it contacts the target. Contact dispensing is characterised in that the liquid drop forms at the tip of the pipette body and is deposited by contact with the target. When performing non-contact dispensing, a liquid sample must be travelling at a high enough velocity to detach from the tip. The distance travelled by the plunger for a dispense shot can be small, for example in the range of 1 mm or less. Consequently, high levels of acceleration/deceleration are needed in order to reach the target velocity for non-contact dispensing.

With an independently operated drive actuator, the plunger mount assembly mechanism—and thus any plunger mounted thereon—can be moved relative to the pipette body mount assembly to perform aspiration and dispense operations independently of the pipette clamp mechanism. The distance travelled by the plunger for a dispense shot can be small, for example in the range of 1 mm or less. Consequently, high levels of acceleration/deceleration are needed in order to reach the target velocity for non-contact dispensing. The independently operated drive actuator can be configured to accelerate and decelerate the plunger mount assembly at sufficiently high rates for both non-contact dispensing and contact dispensing to be possible using the same mechanism.

The term “operate independently” refers to arrangements in which the drive mechanism does not share any components with the pipette clamp mechanism. This allows that drive mechanism to be configured according to the desired acceleration and deceleration characteristics for dispensing and aspirating operations, rather than according to the desired clamping characteristics, or forming some compromise between those characteristics. This is in direct contrast to arrangements in which the pipette bodies and plungers are mounted to plates arranged along common threaded rods and in which all of the drive mechanisms, including those of the actuator by which dispensing operations are controlled, must operate on the same thread pitch. Those arrangements may also require that the movement of the plates is synchronised in order to perform a dispensing operation. This can necessitate more complex control to ensure accurate dispensing and to prevent jamming.

The plunger mounting assembly may comprise a plunger clamping mechanism which is operable to clamp the plungers of the array of pipettes to the plunger mounting assembly, the plunger clamping mechanism comprising a plunger clamping plate, a plurality of plunger clamping members on the plunger clamping plate, and a plunger clamp drive mechanism operable to selectively engage the plunger clamping mechanism, the plunger clamping mechanism having a linear actuator configured to drive relative axial movement between the plunger clamping plate and the plunger mounting assembly to selectively engage the plunger clamping mechanism.

The linear actuator may comprise any suitable actuator. For example, the linear actuator may comprise a solenoid or a pneumatic or hydraulic actuation mechanism. In certain preferred embodiments, the linear actuator of the plunger clamp drive mechanism comprises a plunger clamp motor and a screw mechanism for converting rotational movement of the plunger clamp motor into axial movement of the plunger clamping plate.

The screw mechanism of the plunger clamp drive mechanism may comprise first and second sleeves which are concentric. The first and second sleeves may be coupled by a threaded connection. The second sleeve may be fixed in relation to the plunger mounting assembly. The plunger clamp motor may be configured to rotate the first sleeve about the second sleeve to drive axial movement of the plunger clamping plate.

Preferably, the threaded connection of the plunger clamp drive mechanism has a pitch diameter of less than 40 percent of the width of the plunger clamping plate, preferably less than 30 percent, less than 20 percent, less than 10 percent, or less than 5 percent of the width of the plunger clamping plate. For example, the threaded connection may have a pitch diameter of from 10 mm to 80 mm, from 20 mm to 60 mm, or from 30 mm to 50 mm.

In certain preferred embodiments, the screw mechanism of the plunger clamp drive mechanism is hollow and defines an axial bore in which part of the dispense drive mechanism is received. This has been found to provide a particularly compact structure in which the overall height of the pipetting head can be reduced.

In certain preferred embodiments, the dispense drive mechanism comprises a ball screw actuator nut which is at least partly housed within the axial bore of the screw mechanism of the plunger clamp drive mechanism.

The dispense drive mechanism may extend through the axial bore at a lateral offset to the axis of the screw mechanism. In certain preferred embodiments, the dispense drive mechanism and the screw mechanism of the plunger clamp drive mechanism are concentric.

By arranging the dispense drive mechanism and the screw mechanism such that they are concentric, the dispense drive mechanism and the screw mechanism act along the same single axis. This ensures alignment of the forces applied by dispense drive mechanism and the plunger clamping mechanism and can further help to keep a parallel relationship between the moveable parts of the pipetting head, to further promote smooth operation and reduce the risk of misalignment or crabbing from the uneven application of force across the width of the plunger clamping mechanism. The arrangement allows the screw mechanism to be located centrally within the pipetting head so that the axial force applied to the plunger clamping plate is applied centrally. This can further improve ease of operation and further reduce the risk of misalignment of the plunger clamping plate.

In certain embodiments, the plunger mounting assembly comprises a plurality of plunger mounts, and wherein the plurality of plunger clamping members comprises a plurality of clamping rods which are each coaxial with one of the plurality of plunger mounts and extend within that plunger mount to restrict inward movement of a plunger received in that plunger mount when the plunger clamping mechanism is engaged.

The plunger mounting assembly may further comprise a plunger mounting plate on which the plurality of plunger mounts is provided.

The plurality of plunger mounts may comprise a plurality of axially extending sleeves. Each of the plurality of axially extending sleeves may comprise a radially extending feature on its inner surface which is configured to form one half of a snap-fit connection. The clamping region of each of the plurality of clamping rods may be axially adjacent to the radially extending feature on the inner surface of its associated plunger mount when the plunger clamping mechanism is in the clamp position, and may be axially offset from the radially extending feature on the inner surface of its associated plunger mount when the plunger clamping mechanism is in the release position.

According to a second aspect of the present invention, there is provided a liquid dispensing apparatus comprising: a body with a deck for receiving one or more microplates; and a pipetting head according to the first aspect, the pipetting head being positioned above the deck.

Although the deck is configured to receive one or more microplates, other laboratory equipment may be received on the deck instead of, or in addition to a microplate. For example, one or more arrays of pipette bodies, well plates or microplate transfer devices may be received on the deck, as well as an array of vials or sample tubes, a liquid reservoir, or any other laboratory equipment with which the liquid dispensing apparatus may be used.

Also disclosed is a pipetting head for a liquid dispensing apparatus for use with an array of removable pipettes, each removable pipette having a pipette body and a plunger disposed within the pipette body, the pipetting head comprising: a pipetting head chassis; a pipette body mounting assembly for holding the pipette bodies; a plunger mounting assembly for holding the plungers; a dispense drive actuator assembly operable to move the plunger mounting assembly relative to the pipette body mounting assembly along a drive axis to perform a dispensing or aspirating operation, the dispense drive actuator assembly comprising a dispense drive motor and a dispense drive mechanism by which the dispense drive motor is coupled to the plunger mounting assembly to drive axial displacement thereof; and a plunger clamping mechanism which is operable to clamp the plungers of the array of pipettes to the plunger mounting assembly. The plunger clamping mechanism comprises a plunger clamping plate; a plurality of plunger clamping members on the plunger clamping plate; and a plunger clamp drive mechanism operable to selectively engage the plunger clamping mechanism, the plunger clamping mechanism having a linear actuator configured to drive relative axial movement between the plunger clamping plate and the plunger mounting assembly to selectively engage the plunger clamping mechanism.

### BRIEF DESCRIPTION OF THE DRAWINGS

Further features and advantages of the present invention will be further described below, by way of example only, with reference to the accompanying drawings in which:

FIG. 1 is a front view of a liquid dispensing apparatus with a pipetting head in accordance with the present invention;

FIG. 2 is a perspective view of a pipetting head in accordance with the present invention;

FIG. 3 is a perspective view of the pipetting head of FIG. 2, in which the top cover is removed to show the components beneath;

FIG. 4 is an exploded perspective view of the head chassis of the pipetting head of FIG. 2;

FIG. 5 is a cross-sectional view of the pipetting head of FIG. 2, in which the upper head chassis components are omitted for clarity, and in which the pipette body mounting mechanism and the plunger mounting mechanism are shown;

FIG. 6 is a cross-sectional view through the pipetting head of FIG. 3, in which the plates of the pipette body clamping mechanism and the plunger clamping mechanism are shown;

FIG. 7 is an enlarged view of an upper portion of the cross-sectional view of FIG. 5;

FIG. 8 is an enlarged cross-sectional view of the plates of the pipette body mounting assembly and of the pipette body clamping mechanism of the pipetting head of FIG. 2, in which a pipette body mount sleeve is shown;

FIG. 9 is a cross-sectional view of the plunger mounting assembly and plunger clamping mechanism of the pipetting head of FIG. 2;

FIG. 10 is a cross-sectional view of the plunger clamping mechanism of the pipetting head of FIG. 2;

FIG. 11 is an enlarged cross-sectional view of the plates of the plunger mounting assembly and of the plunger clamping mechanism of the pipetting head of FIG. 2, in which a plunger mount and clamping rod are shown;

FIG. 12 is an enlarged view of a central portion of the cross-sectional perspective view of FIG. 6, showing the dispense drive actuator assembly;

FIG. 13 is a cross-sectional view of a pipette for use with the liquid dispensing system of FIG. 1;

FIG. 14 is a perspective view of the pipette body and the plunger of the pipette of FIG. 13 in which the plunger has been removed from the pipette body;

FIG. 15 is an enlarged cross-sectional view of the pipette of FIG. 13 showing the pipette body connector portion and the plunger connector portion in more detail;

FIG. 16 is a perspective view of the pipette of FIG. 13, showing a pipette body mount and associated pipette body clamp of the pipette body clamping mechanism; and

FIGS. 17 to 21 are enlarged cross-sectional views of part of the pipette body and plunger mounting assemblies and clamping mechanisms during various stages of pipette connection.

### DETAILED DESCRIPTION

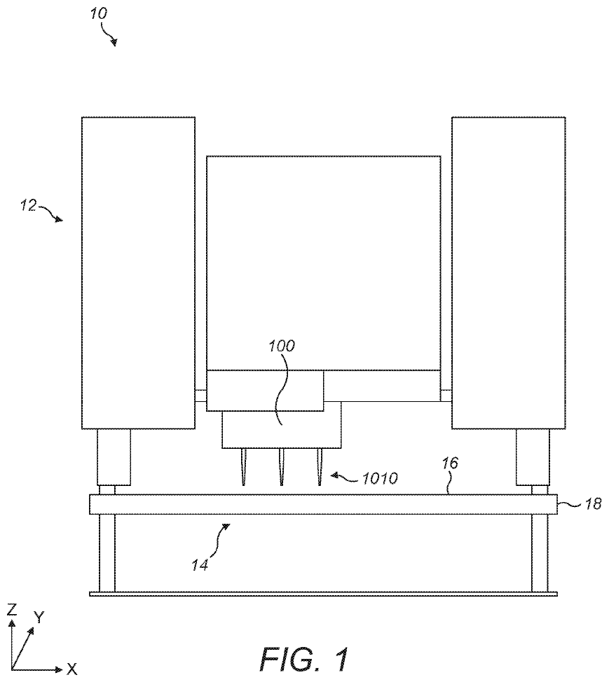

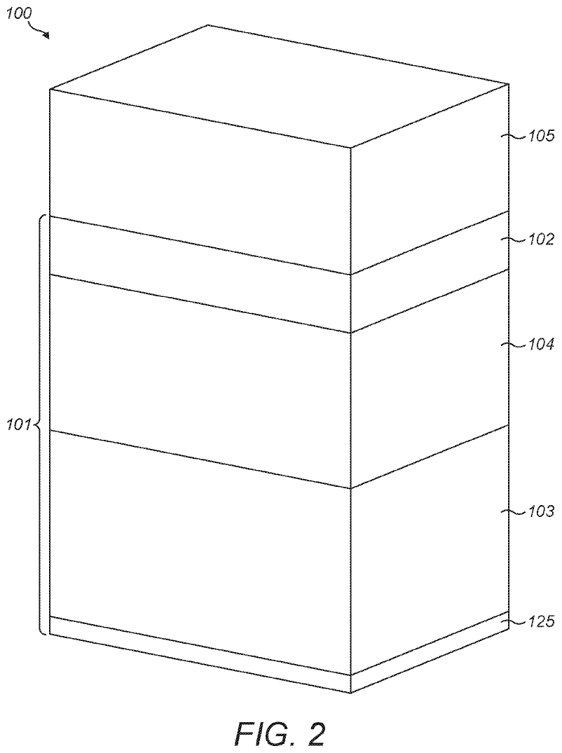

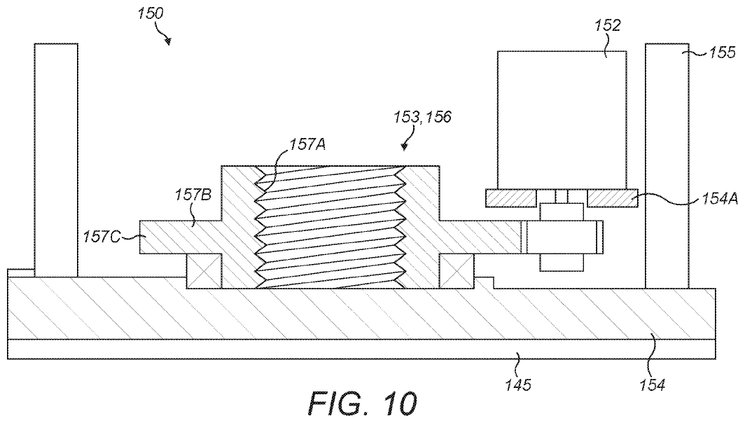

FIG. 1 shows a liquid dispensing apparatus 10 for use with an array of positive displacement pipettes 1010. The apparatus 10 comprises a main body 12 with a microplate receiving area, or deck, 14 and a pipetting head 100 positioned above the microplate receiving area 14. The microplate receiving area 14 is has a substantially horizontal upper surface 16 arranged to receive a laboratory microplate. The receiving area 14 can be located on a height-adjustable support structure 18 which enables the height of the microplate receiving area 14 to be varied as required. The receiving area 14 may be configured to retain a laboratory microplate is a fixed position. For example, the upper surface 16 of the receiving area 14 may comprise one or more recesses (not shown) arranged to receive a microplate and to prevent lateral translation of the microplate with respect to the receiving area 14. The apparatus 10 will generally be used in the orientation shown in FIG. 1 to retain products in wells of the microplate by gravity. The axis marked Z in FIG. 1 therefore represents an upward direction, with gravity acting in the opposite direction to retain the products in the wells of the microplate. References to upward and downward directions or to an axial direction therefore refer to movement along the axis marked Z in FIG. 1, while references to lateral or transverse directions refer to movement in the directions marked X (width) and Y (depth) in FIG. 1. References to vertical direction or height also therefore refer to dimensions or movement along the axis marked Z in FIG. 1. The pipetting head 100 is configured to hold an array of pipettes, as discussed below in relation to FIGS. 2 to 21, and may be moveable in relation to the deck 14 to bring pipettes mounted on the pipetting head 100 into close proximity to a microplate supported on the deck 14 to allow liquid to be aspirated from or dispensed into the wells of the microplate.

FIG. 2 is a perspective view of the pipetting head 100. The pipetting head comprises a head chassis 101 having an upper head chassis part 102, a lower head chassis part 103, and mid head chassis part 104 between the upper and lower head chassis parts, all of which are fixed together to form the main body of the pipetting head 100. A top cover 105 may be removably mounted over the top surface of the upper head chassis part 102. The head chassis 101 is connected to the body of the apparatus by chassis support plates (not shown), which preferably enable the entire pipetting head 100 to be moved in the X, Y and Z directions relative to the receiving area of the apparatus in a conventional manner using one or more head actuators (not shown).

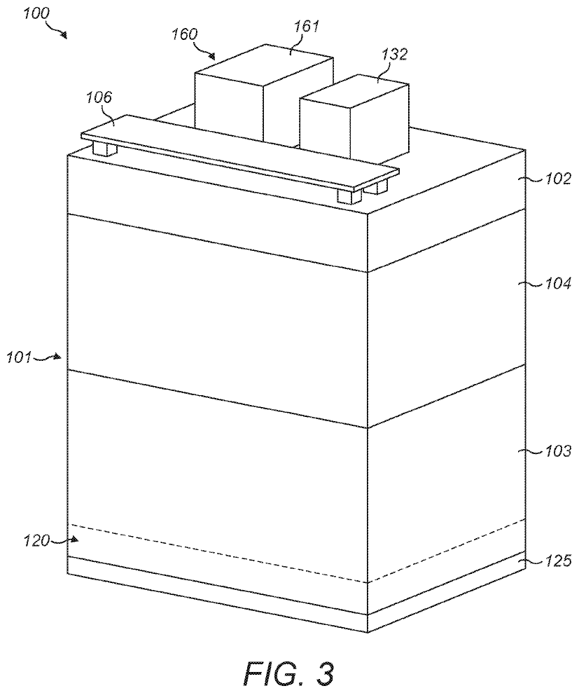

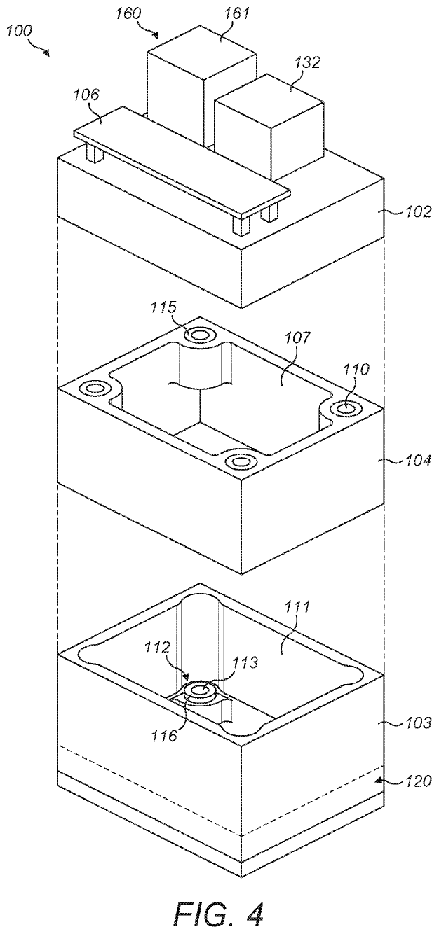

FIG. 3 is a perspective view of the pipetting head 100 with the top cover removed, and FIG. 4 is an exploded view of the head chassis components of the pipetting head 100. The upper head chassis part 102 forms, on its top surface, a support for the dispense drive motor 161 of the dispense drive actuator assembly 160 of the pipetting head 100 and for the pipette body clamp motor 132, which are discussed in more detail below. Control circuitry 106 for the operation of the pipetting head is also fixed to the top surface of the upper head chassis part 102. All of the components mounted on the top surface of the upper head chassis part 102 may be enclosed beneath the top cover 105 when this is placed over the upper head chassis part 102. The mid head chassis part 104 includes an outer wall 107 which is rectangular in transverse cross-sectional shape. The outer wall 107 includes an aperture 110 in each of its four corners. Each aperture 110 may comprise a linear bush 115. The lower head chassis part 103 has an outer wall 111 which defines an internal chamber 112 and, like the upper head chassis part 102 and the mid head chassis part 104, is rectangular in transverse cross-sectional shape. The outer wall 111 includes an aperture 113 in each of its four corners. Each aperture 113 may comprise a linear bush 116.

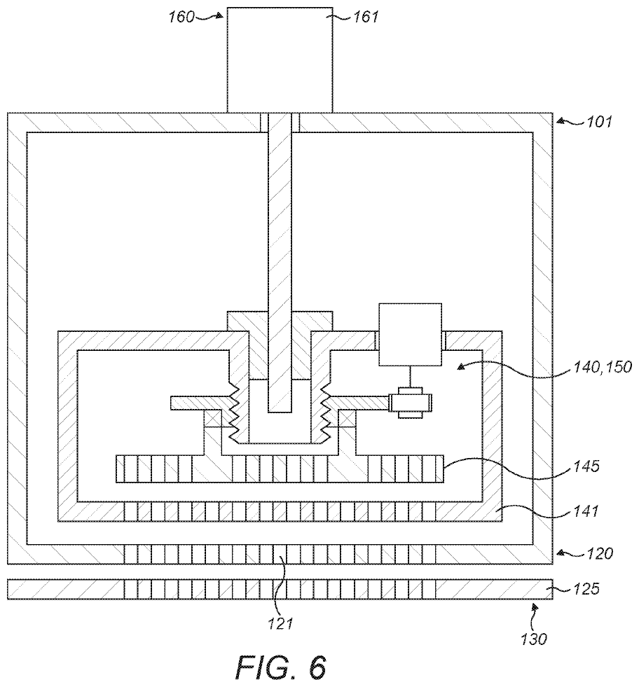

The pipetting head 100 further comprises a pipette body mounting assembly 120 for holding the pipette bodies of an array of positive displacement pipette bodies during use. The pipette body mounting assembly 120 includes a pipette body mounting plate (identified as feature 121 in FIG. 6) which is formed by, integral with or otherwise fixed at the underside of the lower head chassis part 103. The upper head chassis part 102, lower head chassis part 103, and mid head chassis part 104 may be fixed together using any suitable method, for example using bolts and tie-rods.

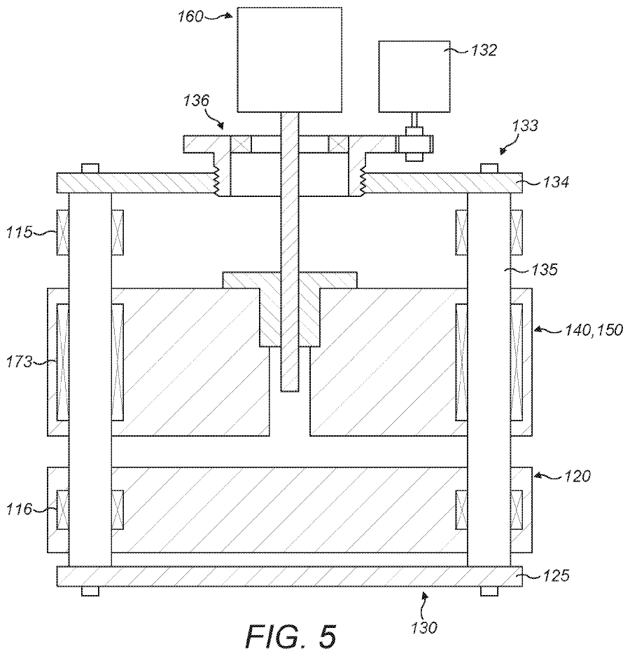

FIG. 5 is a cross-sectional view of the pipetting head 100 with the upper and mid head chassis parts removed for clarity. The pipetting head 100 further includes a plunger mounting assembly 140 for holding the plungers of an array of positive displacement pipette bodies during use. The pipetting head 100 also includes a pipette body clamping mechanism 130 for securely clamping the pipette bodies on the pipette body mounting assembly 120. In this embodiment, the pipetting head 100 also includes a plunger clamping mechanism 150 for securely clamping the plungers on the plunger mounting assembly 140. In other embodiments, the pipetting head could include only one of the two pipette clamping mechanisms. The pipetting head 100 also includes a dispense drive actuator assembly 160 operable to move the plunger mounting assembly 140 relative to the pipette body mounting assembly 120 in an axial direction to perform a dispensing or aspirating operation with an array of pipettes mounted on the pipetting head 100.

With reference to FIGS. 5 to 12, the pipette body and plunger mounting assemblies 120 and 140, the pipette body and plunger clamping mechanisms 130 and 150, and the dispense drive actuator assembly 160 are discussed in more detail.

As best seen in FIGS. 5 to 7, the pipette body clamping mechanism 130 comprises a pipette body clamp plate 125 positioned below the pipette body mounting plate 121, and a pipette body clamp drive mechanism 133 including a linear actuator and a pipette body clamp drive linkage 134, 135. The linear actuator includes a pipette body clamp motor 132 fixed in relation to the head chassis 101 and coupled to the pipette body clamp plate 125 by the pipette body clamp drive linkage 134, 135 to move the clamp plate 125 in the axial direction to selectively engage the pipette body clamping mechanism 130 when the pipette body clamp motor 132 is actuated. The pipette body clamp motor 132 is secured to the top surface of the upper head chassis part 102. The pipette body clamp drive linkage comprises a bearing plate 134 coupled to the linear actuator and a plurality of standoffs 135 extending between the bearing plate 134 and the pipette body clamp plate 125. The linear actuator further includes a screw mechanism 136 connected to the bearing plate 134 and configured to convert rotation of the clamp motor 132 into axial displacement of the standoffs 135 and the clamp plate 125. In this embodiment, the standoffs are provided in the form of guide rods 135 which are supported radially at their upper ends by the linear bushes 115 of the mid head chassis part (feature 104 in FIG. 4) and at their lower ends by the linear bushes 116 of the lower head chassis part (feature 103 in FIG. 4). The guide rods 135 are also radially supported between their upper and lower ends by linear bushes 173 provided in each of the four corners of the plunger mounting assembly 140. In this embodiment, there are four guide rods, one at each corner of the clamp plate 125.

In other embodiments, fewer or more guide rods or standoffs may be provided. For example, the plurality of standoffs may consist of two standoffs positioned on opposite sides of the clamp plate 125, for example at the mid-point between front and back of the clamp plate 125.

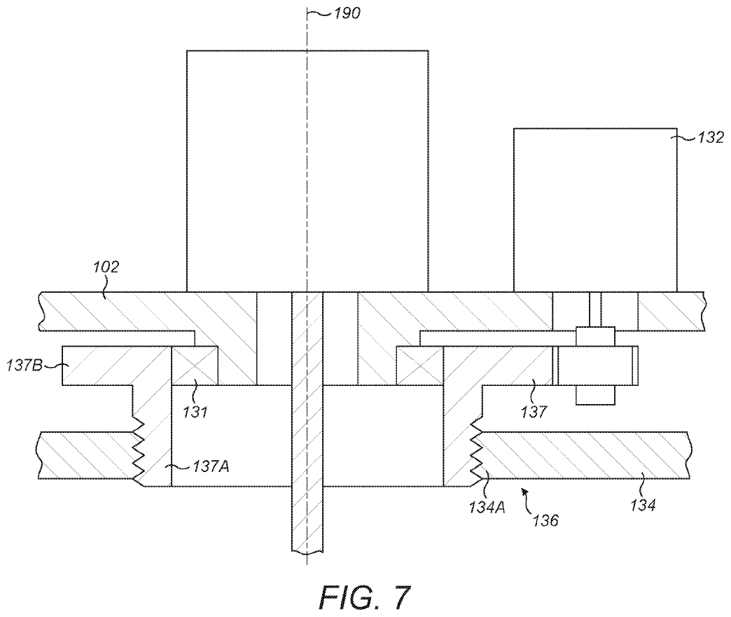

The screw mechanism 136 comprises a ring gear 137 which is coupled to the bearing plate 134 by a threaded connection (see FIG. 7). The ring gear 137 is supported by a bearing 131 which is provided between the upper head chassis part 102 and the ring gear 137. In this manner, the ring gear 137 is fixed in the axial direction relative to the head chassis 101 and is rotatable about the drive axis 190. The clamp motor 132 drives a driving gear 138, the teeth of which mesh with the teeth of the ring gear 137. The ring gear 137 comprises a hollow shaft 137A with a central bore extending in the axial direction, i.e. along the drive axis 190, and a radial flange 137B with a plurality of gear teeth 137C. The radial flange 137B may extend radially outwardly from the hollow shaft 137A. In the illustrated embodiment, the hollow shaft 137A of the ring gear 137 extends within a threaded bore 134A of the bearing plate 134, and the threaded connection between the ring gear 137 and the bearing plate 134 is provided by a screw thread on the outer surface of the hollow shaft 137A of the ring gear 137 and a complimentary screw thread on the inner surface of the threaded bore 134A of the bearing plate 134. The bores of the bearing plate 134 and the hollow shaft 137A together define a central aperture or axial bore. In other embodiments, the bearing plate 134 may include a hollow shaft 134A extending within the bore of the hollow shaft 137A of the ring gear 137, with the threaded connection being provided by a screw thread on the outer surface of the hollow shaft 134A of the bearing plate 134 and a complimentary screw thread on the inner surface of the hollow shaft 137A of the ring gear 137.

When the clamp motor 132 is operated, the driving gear 138 rotates the ring gear 137 and this causes the bearing plate 134 to move axially in relation to the ring gear 137 by virtue of the threaded connection between the ring gear 137 and the bearing plate 134. Rotation of the clamp motor 132 in a first direction causes the bearing plate 134 to move upwards in the axial direction. Rotation of the clamp motor 132 in an opposite, second direction causes the bearing plate 134 to move downwards in the axial direction. Since the bearing plate 134 is fixed to the clamp plate 125 by the guide rods 135, the clamp plate 125 moves axially with the bearing plate 134 to move towards or away from the pipette body mount plate 121. With this configuration of guide rods, the plunger mounting assembly 140 may slide axially along the guide rods when the plunger mounting assembly 140 is moved by the dispense drive actuator assembly and the guide rods may move axially along the linear bushes when the pipette body clamping mechanism 130 is operated. In this manner, the standoffs perform the dual function of transferring axial drive from the bearing plate 134 to the clamp plate 125 and providing a guide along which the plunger mounting assembly 140 is slidably supported. The guide rods 135 help to maintain a parallel relationship between the pipette body mounting plate 121, the pipette body clamping plate 125, and the plunger mounting assembly 140. Due to the dual function of the guide rods 135, it is not necessary to provide separate components to guide the movement of the plunger mounting assembly 140 and to transfer the axial displacement of the bearing plate 134 to the pipette body clamp plate 125. This frees up space within the head chassis 101, allowing larger diameter guide rods 135 to be used while still maintaining a compact structure within the pipetting head. This can further improve performance of the pipetting head by reducing the amount of flex in the guide rods and thereby maintaining a parallel relationship between the moving plates. For example, the guide rods 135 may have a diameter of between 8 mm and 16 mm, e.g. 12 mm.

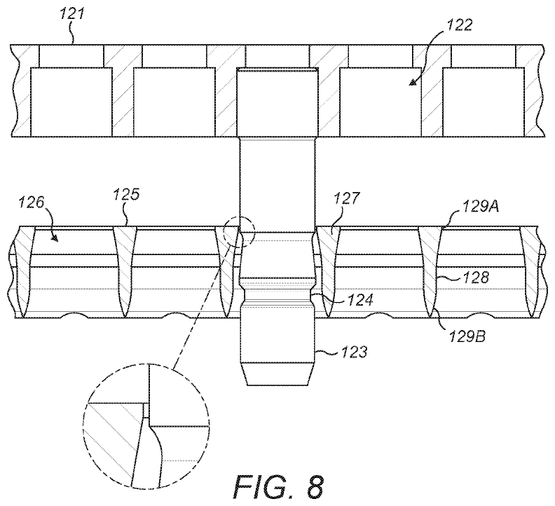

FIG. 8 is an enlarged cross-sectional view through the pipette body mount plate 121 and the pipette body clamp plate 125. The pipette body mounting plate 121 has an array of apertures 122 extending in the axial direction through the thickness of the pipette body mounting plate 121. Secured within each aperture 122 is a pipette body mount 123 extending in a downward axial direction from the plate 121 and configured to couple with one of the pipette bodies during use. Each pipette body mount 123 is in the form of a tubular pipette body mount sleeve retained in one of the array of apertures 122. In this example, the apertures 122 each have a restriction with a diameter which is less than the outer diameter of the pipette body mount sleeves 123. The restrictions prevent the pipette body mount sleeves 123 from being forced through the pipette body mounting plate in an upward direction when the pipette body mount sleeves are initially inserted in the pipette bodies. The upper end of the pipette body mount sleeve 123 preferably comprises an inwardly tapered end surface to assist with the insertion of components of the plunger clamping mechanism through the bore of the pipette body mount sleeve 123. The lower end of the pipette body mount sleeve 123 preferably has an outwardly tapered end surface to assist with the insertion of the lower end of the pipette body mount sleeve into a pipette body. The outer surface of each pipette body mount sleeve 123 comprises a radially extending feature on its outer surface which is configured to form one half of a snap-fit connection with a correspondingly shaped feature on the inner surface of a pipette body. In this example, the radially extending is in the form of an annular groove 124 which circumscribes the pipette body mount sleeve 123.

The pipette body clamping plate 125 has an array of apertures 126 extending in the axial direction through the thickness of the pipette body clamping plate 125. The array of apertures 126 correspond in number and position to the array of apertures 122 of the pipette body mounting plate 121. The pipette body clamping plate 125 further comprises an array of pipette body clamping members 127 each associated with one of the plurality of pipette body mounts 123. In this example, the array of pipette body clamping members 127 are provided in the form of a plurality of clamp sleeves 127 defined by the regions of the pipette body clamping plate 125 which immediately surround the apertures 126 defined in the pipette body clamping plate 125. Each clamp sleeve 127 has a clamping region 128 with an inner diameter which is greater than the outer diameter of its respective pipette body mount sleeve. In this manner, a small clearance is provided between the outer surface of the pipette body mount sleeve 123 and the inner surface of the clamping region 128 when the pipette body clamping mechanism 130 is engaged, as shown in FIG. 8. The pipette body clamp plate 125 is moved by the pipette body clamp drive mechanism 133 between engaged and disengaged, or “released”, states.

When the clamp plate 125 is positioned against or close to the underside of the pipette body mounting plate 121, the clamp sleeves 127 are axially offset from the annular grooves 124 on the pipette body mounts 123. This is the disengaged state, in which pipette bodies can be placed over or removed from the pipette body mounts 123 without interference from the clamp plate 125. To engage the pipette body clamp mechanism, the clamp plate 125 is moved axially away from the pipette body mounting plate 121 until the clamping regions 128 of the clamp sleeves 127 are adjacent to the annular grooves 124 on the pipette body mounts 123. This is the engaged state, in which the clamp sleeves resist or prevent removal of the pipette bodies from the pipette body mounts 123 by preventing the snap-fit connection between the pipette bodies and the pipette body mounts 123 from disconnecting.

Each clamp sleeve may have a substantially constant inner diameter. Alternatively, each clamp sleeve may have regions in which the inner diameter is different, as shown in FIG. 8. In the illustrated example, each clamp sleeve 127 has a narrow region 129A towards its upper end, and a tapered region 129B at its bottom end. The inner diameter of the clamp sleeve 127 decreases in the tapered region 129B from the lowermost tip to the clamping region 128. With this arrangement, one or more pipette bodies can be semi-secured by positioning in the pipette body clamping plate 125 in an intermediate, ‘pre-lock’, position in which the tapered region 129B of the clamp sleeve 127 is adjacent to the recess or annular groove 124 on the outer surface of the pipette body mount sleeve 123. This can facilitate the picking of part arrays of bodies from a box. The picked pipette bodies can then be clamped in place by moving the pipette body clamping plate 125 to the clamping position, once the picked bodies have been raised above the unpicked array. A small clearance may be provided between the narrow region 129A of the clamp sleeve 127 and the outer surface of the pipette body mount 123. This can help to minimise the forces required to move the pipette body clamping plate 125 in the axial direction and facilitate smooth operation of the pipette body clamping mechanism 130.

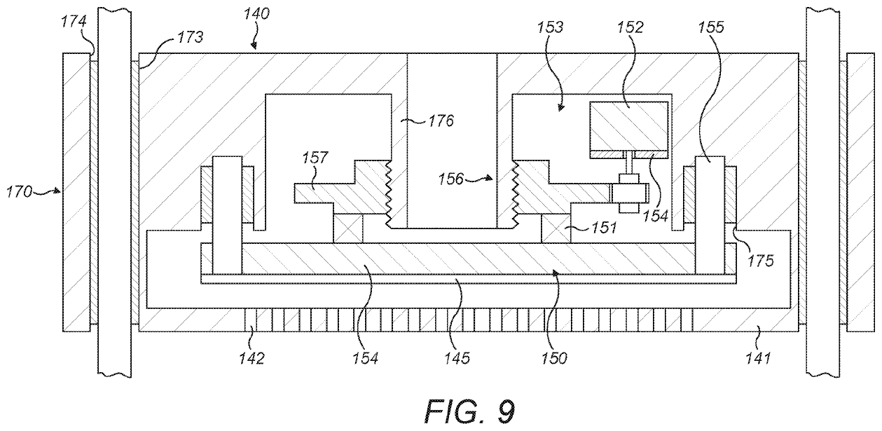

FIG. 9 is a cross-sectional view of the plunger mounting assembly 140 and the plunger clamping mechanism 150. The plunger mounting assembly 140 and the plunger clamping mechanism 150 are movable together in the axial direction by the dispense drive actuator assembly 160. The plunger clamping mechanism 150 is moveable in the axial direction relative to the plunger mounting assembly 140.

As best seen in FIGS. 9 to 11, the plunger mounting assembly 140 comprises a plunger mounting plate 141 with a plurality of apertures 142. The plunger mounting assembly 140 comprises a box-shaped housing 170 within which the components of the plunger mounting assembly 140 and the plunger clamping mechanism 150 are at least partly housed. For ease of assembly, the housing 170 preferably has a two-part construction comprising an upper housing and a lower housing which are fixed together around the plunger clamping mechanism 150. The plunger mounting plate 141 forms the lower surface of the housing 170. The housing 170 is rectangular in cross-sectional shape view and comprises an axially extending linear bush 173 in each corner. The linear bushes 173 are supported within apertures 174 in the housing 170 so that the entire assembly shown in FIG. 9 can move up and down along the guide rods of the pipette body clamping mechanism.

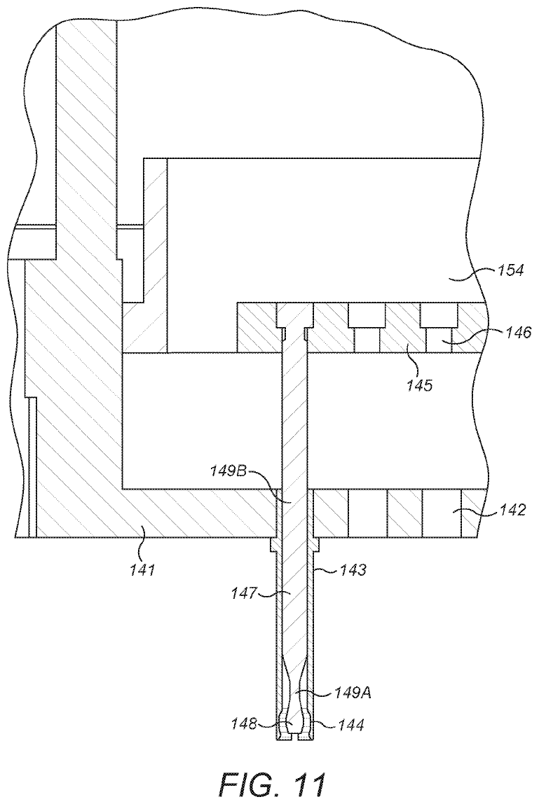

The plunger clamping mechanism 150 comprises a plunger clamping plate 145 positioned above the plunger mounting plate 141, a plurality of plunger clamping members 147 (see FIG. 11) on the plunger clamping plate 145, and a plunger clamp drive mechanism 153, operable to selectively engage the plunger clamping mechanism. The plunger clamp drive mechanism comprises a linear actuator 153 configured to drive relative axial movement between the plunger clamping plate and the plunger mounting assembly to selectively engage the plunger clamping mechanism. The linear actuator 153 comprises a plunger clamp motor 152 fixed in relation to the plunger clamp plate 145, and coupled to the plunger mounting assembly 140 to move the plunger clamp plate 145 relative to the plunger mount plate 141 in the axial direction to selectively engage the plunger clamping mechanism 150 when the clamp motor 152 is actuated. The plunger clamping mechanism 150 further includes a plunger clamp support plate 154 and a motor support plate 154A which is fixed to the plunger clamp support plate 154. The plunger clamp plate 145 is fixed to the underside of the plunger clamp support plate 154. The plunger clamping mechanism may further include plunger clamp guide rods 155 which guide the plunger clamp plate 145 during movement of the plunger clamping mechanism 150. In this embodiment, the plunger clamp guide rods 155 are fixed in relation to the plunger clamp support plate 154 and slide within apertures 175 in the housing 170 which are located inboard of the apertures 174. In other embodiments, the plunger clamp guide rods may be fixed to the housing 170 and the support plate comprise apertures which slide along the outside of the guide rods.

The plunger clamp drive mechanism 153 comprises a screw mechanism 156 configured to convert rotation of the clamp motor 152 into axial displacement of the clamp plate 145. The screw mechanism 156 comprises a ring gear 157 and a hollow shaft 176 which are coupled together by a threaded connection. The hollow shaft 176 extends along the drive axis 190 and is fixed to the housing 170 of the plunger mounting assembly 140. The ring gear 157 is supported by a bearing 151 which is provided between the plunger clamp support plate 154 and the ring gear 157. In this manner, the ring gear 157 is fixed in the axial direction relative to the plunger clamp support plate 154 and is rotatable about the drive axis 190. The ring gear 157 comprises a central bore 157A extending in the axial direction, i.e.

along the drive axis 190, and a radial flange 157B with a plurality of gear teeth 157C. The radial flange 157B may extend radially outwardly from the hollow shaft 157A. The bores of the hollow shaft 176 and of the ring gear 157 together define a central aperture or axial bore. In the illustrated embodiment, the bore 157A of the ring gear 157 extends around the hollow shaft 176 fixed to the housing 170, and the threaded connection between the ring gear 157 and the hollow shaft 176 is provided by a screw thread on the outer surface of the hollow shaft 176 and a complimentary screw thread on the inner surface of the bore 157A of the ring gear 157. In other embodiments, the ring gear 157 may include a threaded shaft which extends within the bore of the hollow shaft 176 of the housing 170, with the threaded connection being provided by a screw thread on the outer surface of the hollow shaft of the ring gear 157 and a complimentary screw thread on the inner surface of the hollow shaft 176.

The clamp motor 152 drives a driving gear 158, the teeth of which mesh with the teeth 157C of the ring gear 157. When the clamp motor 152 is operated, the driving gear 158 rotates the ring gear 157 around the hollow shaft 176. Due to the threaded connection between the ring gear 157 and the hollow shaft 176, rotation of the ring gear 157 causes the ring gear 157 to move axially up or down the hollow shaft 176. Due to the axial fixation of the ring gear 157 in relation to the plunger clamp support plate 154, axial movement of the ring gear 157 causes axial movement of the rest of the plunger clamping mechanism 150, with the exception of the hollow shaft 176 which is fixed in relation to the housing 170. Rotation of the clamp motor 152 in a first direction causes the ring gear 157 to move upwards in the axial direction along the hollow shaft 157. Rotation of the clamp motor 152 in an opposite, second direction causes the plunger clamping mechanism 150 to move downwards in the axial direction. Since the clamp plate 145 is fixed to the plunger clamp support plate 154, the clamp plate 145 moves axially with the plunger clamp support plate 154 to move towards or away from the plunger mount plate 141.

FIG. 11 is an enlarged cross-sectional view of part of the plunger mounting assembly 140 and the plunger clamping mechanism 150, showing the plunger mounting plate 141 and the plunger clamp plate 145 in more detail. The plunger mounting plate 141 has an array of apertures 142 extending in the axial direction through the thickness of the plunger mounting plate 141. Secured within each aperture 142 is a plunger mount 143 extending in a downward axial direction from the plate 141 and configured to couple with one of the plungers during use. Each plunger mount 143 is in the form of a tubular plunger mount sleeve retained in one of the array of apertures 142. In this example, the plunger mounts 143 each have a shoulder having an outer diameter which is greater than the diameter of the apertures 142 and which abuts against the underside of the plunger mount plate 141. The shoulder helps to set the height of the plunger mount sleeve 143 when initially inserted into an aperture 142 in the plunger mount plate 141. The lower end of the pipette body mount sleeve 143 preferably has an inwardly tapered end surface to assist with the insertion of a plunger into the bore of the plunger mount sleeve 143. Each plunger mount sleeve 143 comprises a radially extending feature on its inner surface which is configured to form one half of a snap-fit connection with a correspondingly shaped feature on the outer surface of a plunger. In this example, the radially extending feature is in the form of an annular groove 144 in the inner surface of the plunger mount sleeve 143 towards its lower end.

The plunger clamping plate 145 has an array of recesses or apertures 146 extending in the axial direction. The array of apertures 146 of the plunger clamping plate 145 correspond in number and position to the array of apertures 142 of the plunger mounting plate 141. The array of apertures 146 of the plunger clamping plate 145 may also correspond in number to the arrays of apertures 122 and 126 of the pipette body mounting and clamping mechanisms. The plunger clamping plate 145 further comprises an array of plunger clamping members 147 each associated with one of the plurality of plunger mounts 143. The array of plunger clamping members is provided in the form of a plurality of clamping rods 147 which extend axially from the plunger clamping plate 145 and extend into the bores defined within the plunger mount sleeves 143. Each clamping rod 147 has an enlarged head 148 at its lower end which extends from a narrower neck region 149A. The enlarged head 148 has an outer diameter which is less than the inner diameter of the plunger mount sleeve 143. In this manner, a small clearance is provided between the outer surface of the enlarged head 148 and the inner surface of the plunger mount sleeve 143 when the plunger clamping mechanism is engaged. The neck 149A has an outer diameter which is less than that of the enlarged head 148. Preferably, each clamping rod 147 also has a main shaft 149B with an outer diameter which is substantially the same as the inner diameter of the region of the plunger mount sleeve 143 in which it is located. The main shaft 149B moves axially along the bore of the plunger mount 143 as the plunger clamping plate 145 is moved up and down in the axial direction relative to the plunger mount plate 141.

The relative movement between the plunger clamping plate 145 and the plunger mounting plate 141 allows the plunger clamping mechanism 150 to be moved into any position between an engaged state, in which a plunger is clamped in position, and a disengaged, or “released” position or state, in which a plunger may be mated with or removed from the plunger mounts in an axial direction. The plunger clamping mechanism 150 may be configured to move to an ejection state, in which the plunger clamping plate 145 is moved towards the plunger mounting plate 141 beyond the clamping position. In this position, the enlarged heads 148 of the clamping rods 147 are axially below the radially extending features on the inner surfaces of the plunger mount sleeves 143, which are instead in alignment with the narrower neck portions 149A of the clamping rods. This allows the top of the plunger, i.e. the plunger connector portion, to flex inwards. Further downward movement of the clamping plate 145 and clamping rods 147 pushes the plunger downwards to release it from the snap-fit connection with the plunger mounting sleeves. When the pipette body clamping plate 125 is also in a released position, further downward movement of the clamping rod using the plunger clamping drive mechanism pushes the plunger against one or more inside surfaces of the pipette body, for example the region around the aperture at the distal end of the pipette body, to push the pipette body from the pipette body clamping mechanism. This ejects the entire pipette assembly from the pipetting head. Alternatively, the clamping rod and the plunger may be moved down together using the direct drive actuator 160 to push against the pipette and thereby eject the pipette body from the apparatus. In this ejection mode, the plunger may remain on the apparatus even after the pipette body has been ejected.

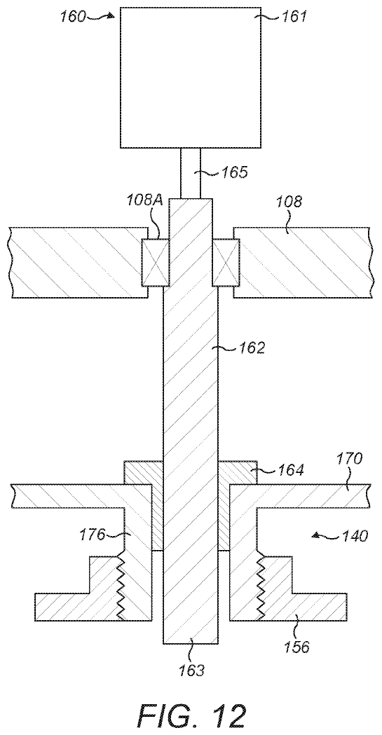

As best seen in FIG. 12, the dispense drive actuator assembly 160 comprises a dispense drive motor 161 and a dispense drive mechanism 162 by which the dispense drive motor 161 is directly coupled to the plunger mounting assembly 140 to drive axial displacement thereof. The dispense drive motor 161 is mounted on the top surface of the upper head chassis part 102. The dispense drive mechanism 162 includes the output shaft 165 of the dispense drive motor 161, a threaded rod 163, and a ball screw actuator nut 164 with which the threaded rod 163 forms a ball screw actuator. The output shaft of the drive motor 161 may be integral with, i.e. unitary with, the threaded rod 163, or a discrete component which is fixed with respect to the threaded rod 163 for rotation therewith. The ball screw nut 164 is axially fixed in relation to the plunger mounting assembly 140 so that the two move simultaneously along the threaded rod 163 when the threaded rod 163 rotates. In the illustrated embodiment, the ball screw nut 164 is fixed within the hollow shaft 176 of the housing 170 of the plunger mounting assembly 140.

The threaded rod 163, ball screw actuator nut 164, screw mechanism 136 and screw mechanism 156 are all co-axial. In other words, the central axes of all of these components are aligned along a common axis. One or both of the output shaft 165 of the drive motor 161 and the threaded rod 163 extend through the axial bore defined by the screw mechanism 136 of the pipette body clamping mechanism. One or both of the threaded rod 163 and the ball screw nut 164 may extend through the axial bore defined by the screw mechanism 156 of the pipette body clamping mechanism. In this manner, the dispense drive mechanism 162 is concentric with the screw mechanism 136 and with the screw mechanism 156 along at least a part of the length of the dispense drive mechanism 162.

With this arrangement, the forces applied by the various drive mechanisms all act along the same single axis, which is preferably central. This can help to keep the movable plates parallel with each other to promote smooth operation and reduce the risk of crabbing. Further, each drive mechanism applies a force in a single location. This avoids the risk of crabbing due to the uneven application of force at multiple locations. For example, where the force is applied at each of the four corners of a plate by a pulley and belt arrangement, failure to keep the force at each pulley even can lead to crabbing of the plate.

Referring to FIG. 5, when the dispense drive actuator assembly 160 is operated, the entire plunger mounting assembly 140 is moved in the axial direction along guide rods 135 either towards or away from the pipette body mounting assembly 120, depending on the direction of rotation of the dispense drive motor 161. The linear bushes 173 slide along the outer surface of the guide rods 135 so that the plungers held by the plunger mounting assembly 140 can be accelerated rapidly and accurately relative to the pipette bodies within which the plungers extend and independently of any restriction imposed by the speed of operation of the clamping mechanism. This allows the apparatus to be used in a non-contact dispensing mode (also known as jetting-in which liquid is dispensed from the pipette at a distance from the target so that the drop separates from the tip of the pipette body before it contacts the target) as well as a contact dispensing mode (in which the liquid drop forms at the tip of the pipette body and is deposited by contact with the target). When performing non-contact dispensing, a liquid sample must be travelling at a high enough velocity to detach from the tip. The distance travelled by the plunger for a dispense shot can be small, for example in the range of 1 mm or less. Consequently, high levels of acceleration/deceleration are needed in order to reach the target velocity for non-contact dispensing. The linear bushes 173 align the mating parts of the pipetting head assembly to minimise tolerance stack-up. Additionally, the use of linear bushes has been found to be an extremely effective way to maintain squareness, or a parallel relationship, between the plunger mounting assembly and the pipette body mounting assembly and the pipette body clamping mechanism. The direct drive arrangement, for example via a ball screw, can offer higher levels of acceleration/deceleration of heavy loads than a belt driven system, thus enabling non-contact dispensing of low volume liquid samples. Furthermore, a direct drive arrangement can offer higher positional accuracy and repeatability than an equivalent belt drive mechanism. This can have a significant impact on dispense performance.

In this manner, the dispense drive mechanism 162 is concentric with the screw mechanism 136 and with the screw mechanism 156 along at least a part of the length of the dispense drive mechanism 162.

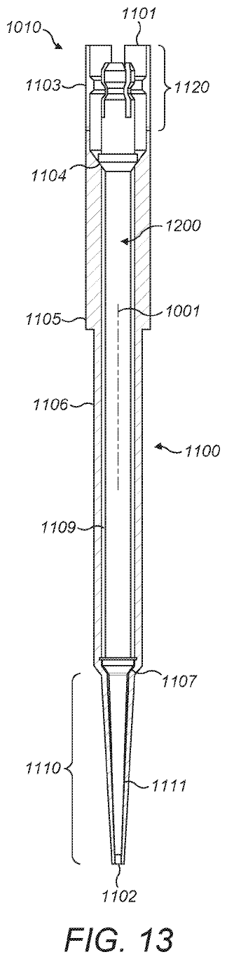

FIGS. 13 to 17 show a pipette 1010 for use with the pipetting head of FIGS. 2 to 12. The pipette 1010 comprises a pipette body 1100 and a plunger 1200.

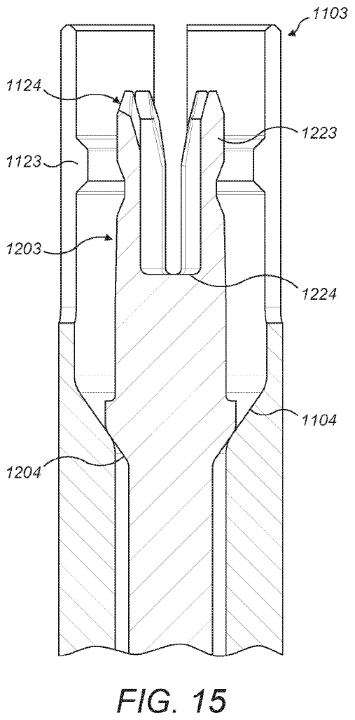

The pipette body 1100 may be a receptacle for receiving and/or containing a sample fluid, or a sample liquid. The pipette body 1100 may be configured for insertion into a container of sample liquid, or into sample liquid. The pipette body 1100 has a proximal end 1101 and a distal end 1102 defining a longitudinal axis 1001 therebetween. The pipette body 1100 has an aperture 1108 at its distal end 1102, as indicated in FIG. 15. The aperture 1108 may be defined by an inner wall surface 1111 of the pipette body 1100 at the distal end 1102, specifically at an outermost distal point of the pipette body 1100. The aperture 1108 may be any suitable shape, e.g. elliptical, oval, or circular. The pipette body 1100 has a fluid cavity 1109 extending from the aperture 1108 at least partially towards the proximal end 1101. The fluid cavity may be configured to receive and/or retain a fluid, such as an airgap or sample liquid. The fluid cavity 1109 may be substantially elongate. The fluid cavity may be defined by the inner wall surface of the pipette body 1100. The longitudinal axis 1001 may be a central axis about which the pipette body 1100 and/or plunger 1200 is disposed. The longitudinal axis 1001 may define a central axis about which the pipette body 1100 and/or plunger 1200 are disposed uniformly or symmetrically. The pipette body 1100 and/or plunger 1200 may be configured so that the direction of aspirating and/or dispensing is along the longitudinal axis 1001. The pipette body 1100 may be substantially elongate, extending between its proximal and distal ends, 1101, 1102. The pipette body 1100 may be substantially or entirely hollow. The pipette body 1100 may comprise or consist of a polymeric material. The pipette body 100 may comprise or consist of a homogeneous material. The pipette body 100 may comprise or consist of a translucent or transparent material.

The pipette body 1100 may comprise a series of portions, each having a different function, distinguishing features and/or a different shape or dimension. The pipette body 1100 may comprise one or more of: a pipette body connector portion 1103, a centering portion 1104, a support portion 1105, a main body portion 1106, and a bridging portion 1107, for example as shown in FIG. 15. From the proximal end 1101 to the distal end 1102, each portion may be arranged in the order: pipette body connector portion 1103, centering portion 1104, support portion 1105, main body portion 1106, bridging portion 1107, and end portion 1110. The fluid cavity 1109 may extend through one, more or all of the portions of the pipette body 1100. The plunger 1200 may extend through one, more or all of the portions of the pipette body 1100.

The pipette body connector portion 1103 is configured for connection to a liquid handling system, for example with a snap-fit connection. The pipette body connector portion 1103 may comprise a split tubular wall 1120 which may be defined by a plurality of flexible segments 1121. The flexible segments 1121 may be configured to resiliently deflect in a radially outward direction to increase the outer diameter of the proximal end 1101 of the pipette body 1100 from a first outer diameter, in which the flexible segments are undeflected and the pipette body connector portion is in a rest state, to a second outer diameter, in which the flexible segments are deflected radially outwardly and the pipette body connector portion is in an expanded state. In the embodiment depicted, the pipette body connector portion 1103 comprises four axially extending discontinuities or slots 1122 in the tubular wall 1120 which separate four flexible segments 1121. The pipette body connector portion 1103 may comprise any suitable number of axially extending discontinuities 1122 to define any number of flexible segments 1121, such as two, three, four, five, or six. The arrangement of flexible segments 1121 and slots 1122 enables the pipette body connector portion to expand without requiring significant forces to be exerted on the pipette body connector portion. This can reduce the insertion force required to engage the pipette body connector portion 1103 with the pipetting head.

The pipette body connector portion 1103 may further comprise one or more radially extending features 1123 on its inner surface by which the pipette body may be coupled to the pipetting head. The radially extending feature on the inner surface of the pipette body connector portion 1103 may comprise a protrusion, which extends radially inward, and/or a recess or groove, which extends radially outward. The radially extending feature may extend in a circumferential direction. In the depicted embodiment, the radially extending feature on the inner surface of the pipette body connector portion 1103 comprises a part-annular rib 1123 which protrudes from the inner surface of the pipette body connector portion 1103. Preferably, the second outer diameter to which the pipette body connector portion is increased is larger than the first outer diameter by at least the radial extent of the radially extending feature 1123. The rib 1123 preferably comprises angled upper and lower surfaces along which the inner diameter of pipette body connector portion gradually increases from the rib 1123 to the regions of the pipette body connector portion above and below the rib 1123. The angle of the upper surface can be selected according to the desired insertion force. The angle of the lower surface can be selected according to the desired ejection force. The upper or lower surfaces may each have an angle of from 10 to 80 degrees from the axial direction of the pipette body, for example from 20 to 70 degrees from the axial direction of the pipette body, 30 to 60 degrees from the axial direction of the pipette body, or 40 to 50 degrees from the axial direction of the pipette body.

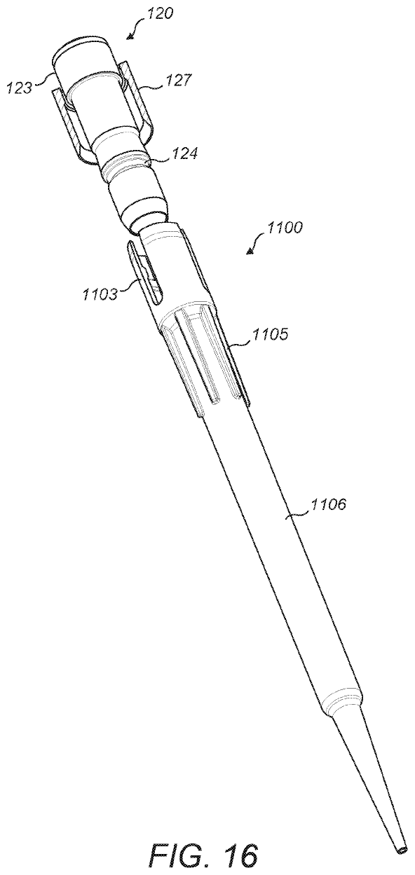

The centering portion 1104 may be configured to centre the plunger 1200 within the pipette body 1100. The centering portion 1104 may have an inner surface which may have a tapered or conical shape. The support portion 1105 may comprise one or more structural ribs or rings, configured to reduce flexibility and/or improve structural integrity of the pipette body 1100. The one or more ribs may extend on an outer surface of the pipette body, along at least part of the length between the proximal end 1101 and distal end 1102, for example axially, as best seen in FIG. 16. The main body portion 1106 may be substantially cylindrical and/or elongate. The main body portion 1106 may have a substantially uniform inner diameter and/or outer diameter. The main body portion 1106 may extend along at least half of the length of the pipette body 1100. The main body portion 1106 may have a larger inner and/or outer diameter than any diameter of the end portion 1110. The bridging portion 1107 may be configured to bridge the main body portion 1106 to the end portion 1110. The bridging portion 1107 may define a gradual transition or a step between the main body portion 1106 and the end portion 1110. The bridging portion 1107 may be substantially tapered, conical and/or dome shaped.

The plunger 1200 has a proximal end 1201 and a distal end 1202 extending along the longitudinal axis 1101. The plunger 1200 is configured to extend at least partly between the proximal and distal ends 1101, 1102 of the pipette body 1100 into the end portion 1110. The plunger 1200 may be configured to extend substantially or wholly between the proximal and distal ends 1101, 1102 of the pipette body 1100 into the end portion 1110. The plunger 1200 is movable towards and away from the aperture 1108 to aspirate or dispense fluid from the pipette body 1100. The plunger 1200 may have an end portion outer wall surface 1212 configured for alignment with the inner wall surface 1111 of the pipette body end portion 1110. The plunger 1200 may comprise or consist of a polymeric material. The plunger 1200 may comprise or consist of a homogeneous material.

The plunger 1200 may comprise a series of portions, each having a different function, distinguishing features and/or a different shape or dimensions. The plunger 1200 may comprise one or more of: a plunger connector portion 1203, a centering portion 1204, a main body portion 1206, and a sealing portion 1207. From the proximal end 1201 to the distal end 1202, each portion may be arranged in the following order: connector portion 1203, centering portion 1204, main body portion 1206, sealing portion 1207 and end portion 1210.

The plunger connector portion 1203 is configured for connection to a liquid handling system, for example with a snap-fit connection. The plunger connector portion 1203 may be configured to be received entirely within the pipette body connector portion 1103 of the pipette body 100. The plunger connector portion 1203 may comprise a split tubular wall 1220 which may be defined by a plurality of flexible segments 1221. The flexible segments 1221 may be configured to resiliently deflect in a radially inward direction to decrease the inner diameter of the proximal end 1201 of the plunger 1200 from a first inner diameter, in which the flexible segments are un-deflected and the plunger connector portion is in a rest state, to a second inner diameter, in which the flexible segments are deflected radially inwardly and the plunger connector portion is in a compressed state. In the embodiment depicted, the plunger connector portion 1203 comprises three axially extending discontinuities or slots 1222 in the tubular wall 1220 which separate three flexible segments 1221. The plunger connector portion 1203 may comprise any suitable number of axially extending discontinuities 1222 to define any number of flexible segments 1221. The arrangement of flexible segments 1221 and slots 1222 enables the plunger connector portion to be compressed without significant compressive stresses. The plunger connector portion 1203 may further comprise one or more radially extending features 1223 on its outer surface by which the plunger may be coupled to the pipetting head. The radially extending feature on the outer surface of the plunger connector portion 1203 may comprise a protrusion, which extends radially outward, and/or a recess or groove, which extends radially inward. The radially extending feature may extend in a circumferential direction. In the depicted embodiment, the radially extending feature on the outer surface of the plunger connector portion 1203 comprises a bulbous head 1223 at the upper end of the plunger which is defined above an annular groove in the outer surface of the plunger connector portion 1203. Preferably, the second inner diameter to which the plunger connector portion is decreased is smaller than the first inner diameter by at least the radial extent of the radially extending feature 1223, i.e. by at least half the difference between the outer diameter of the bulbous head 1223 and the outer diameter at the narrowest part of the annular groove.

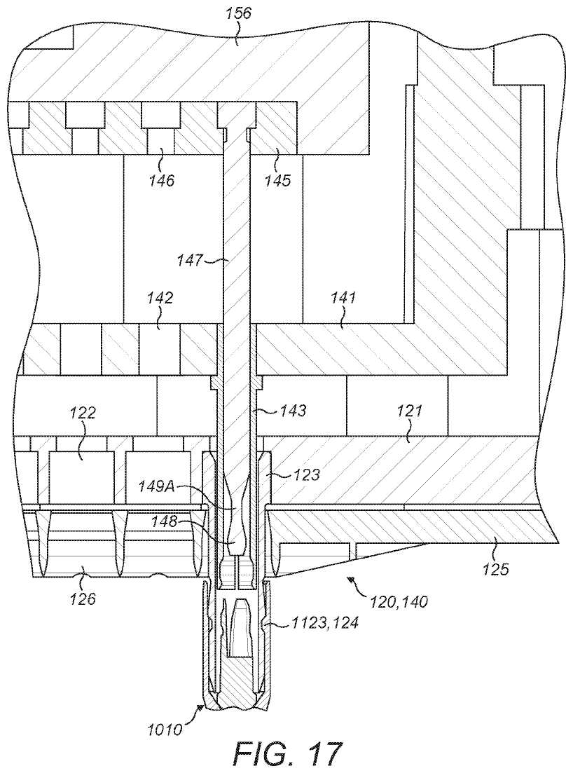

The plunger connector portion 1203 may further comprise an internal wall 1224 extending transversely from the inner surface of the plunger connector portion 1203. The internal wall 1224 may be positioned distally of the flexible segments 1221. The internal wall 1224 may be positioned proximally of the main body portion 1206. The internal wall 1224 forms a restriction across the bore of the plunger connector portion. This provides a surface against which the head of the clamping rods can abut to eject the pipettes. The internal wall 1224 may extend across the full width of the interior bore of the plunger 1200, as illustrated in FIG. 17. However, this is not necessarily the case. The inner wall 1224 need only restrict the size of the bore to less than the outer diameter of the head of the clamping rod.

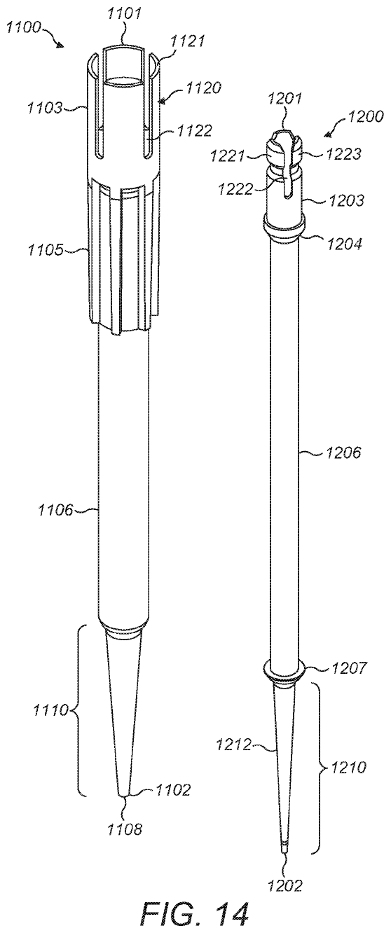

The centering portion 1204 may comprise an annular shoulder. The centering portion 1204 may be substantially conical or dome shaped. In the depicted embodiment, the centering portion 1204 is a radially extending frustoconical shoulder. The centering portion 1104 of the pipette body 1100 is preferably configured to receive and engage with the centering portion 1204 of the plunger 1200 to centre the alignment of the plunger. In the embodiment depicted in FIG. 14, the two centering portions have corresponding geometries. The main body portion 1206 of the plunger 1200 may be configured to be received in the main body portion 1106 of the pipette body 1100. The main body portion 1206 may be substantially cylindrical and/or elongate. The main body portion 1206 may have a substantially uniform diameter. The main body portion 1206 may extend along at least half of the length of the plunger, optionally at least two thirds of the length of the plunger 1200. The main body portion 1206 may have a larger diameter than the diameter of the end portion 1210. The sealing portion 1207 of the plunger 1200 may be configured to be received in the bridging portion 1107 of the pipette body 1100. The sealing portion 1207 may be configured to form a seal against an inner wall of the pipette body 1100. The sealing portion 1207 may form a fluid-tight seal within the pipette body, such that fluid cannot pass from a proximal side of the sealing portion 1207 to a distal side of the sealing portion 1207 when the plunger 1200 is installed in the pipette body 1100. The sealing portion 1207 may be at least partly flexible. The sealing portion 1207 may be configured to bridge the main body portion 1206 to the end portion 1210. The sealing portion 1207 may define a step between the main body portion 1207 and the end portion 1210. The sealing portion 1207 may be substantially tapered, conical and/or dome shaped. The end portion 1210 of the plunger 1200 may be configured to be received in the end portion 1110 of the pipette body 1100. The end portion 1210 may have a smaller diameter than the sealing portion 1207 and/or the main body portion 1206.

With reference to FIGS. 17 to 21, a method of connecting a pipette 1010 to the pipetting head 100 of the present invention will now be described. Although the Figures to which the below discussion relates show only a single pipette, it will be understood that one or more of the connecting, aspirating, dispensing and ejecting operations discussed may be applicable to multiple pipettes simultaneously. For example, where the pipetting head comprises 384 mounts, the below discussion may apply to the simultaneous connection of 384 pipettes, or any subset thereof.

In FIG. 17, the pipette body clamping mechanism 130 and the plunger clamping mechanism 150 are both in their released states. When the pipette body clamping mechanism 130 is in the released state, the pipette body clamping plate 125 is in its uppermost position against the underside of the pipette body mounting plate 121. Crucially, in this position, the clamping regions of the pipette body clamp sleeves are axially offset from the annular grooves around the outer surfaces of the pipette body mount sleeves. When the plunger clamping mechanism 150 is in its released state, the plunger clamping plate 145 is in its uppermost position and the enlarged heads 148 of the plunger clamping rods 147 are axially offset from the annular groove on the inner surface of each of the plunger mount sleeves, as shown. The entire pipetting head 100 is then moved using the pipette head Z motor (not shown) axially towards an array of pipettes 1010 such that the pipette body mount sleeves are received within the pipette body connector portions of the pipette bodies 1100. During insertion of the pipette body mount sleeves 123 into the proximal ends of the pipette bodies 1100, the annular ribs 1123 on each pipette body 1100 ride over the outer surface of the pipette body mount sleeve 123, causing the pipette body connector portion of each pipette body to be outwardly deflected to the expanded position. Once the annular rib 1123 is received in the annular groove 124, as shown in FIG. 17, the flexible segments return to an un-deflected, or only partially deflected state. In this position, the pipette body connector portion is in a rest state and each pipette body 1100 is coupled to its respective pipette body mount sleeve 123 in a snap fit connection. This is step 1.

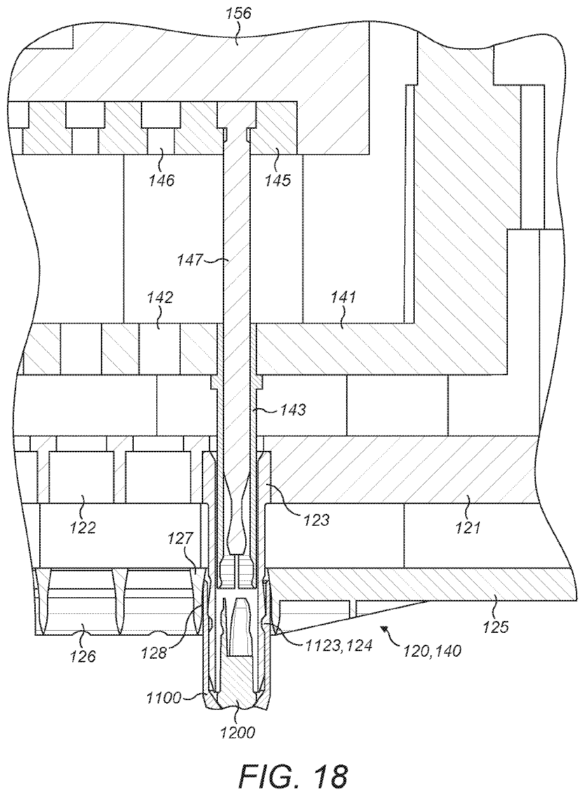

Step 2 is discussed with reference to FIG. 18. In step 2, the pipette body clamping mechanism 130 is engaged by lowering the pipette body clamping plate 125 and moving it away from the pipette body mounting plate, as shown in FIG. 18. This causes the pipette body clamping sleeves 127 to extend around the pipette body connector portion 1103 of each pipette body 1100 such that the clamping region of each pipette body clamping sleeve is adjacent to the snap fit connection between each pipette body 1100 and its respective pipette body mount sleeve 123. The inner diameter of the clamping region 128 is less than the expanded diameter of the pipette body connector portion 1103, for example it may be substantially the same as the unexpanded, or “first”, outer diameter of the pipette body connector portion. With this arrangement, the pipette body connector portion 1103 is prevented from expanding fully, thus preventing the radially extending feature 1123 on the inner surface of the pipette body 1100 from being released from the groove 124 on the outer surface of the pipette body mount sleeve 123. In this manner, the pipette body 1100 is “locked” or “clamped” in position without the need to exert any significant forces on the pipette body connector portion of the pipette body 1100. This can reduce the force required to engage the pipette body clamping mechanism.

Between steps 1 and 2, the pipette body clamping mechanism may optionally be moved to a partially engaged, ‘pre-lock’, position between the released and engaged states, in which the tapered region 129B of each clamp sleeve 127 is adjacent to the recess 124 on the outer surface of its respective pipette body mount sleeve 123. This can facilitate the picking of part arrays of bodies from a box by allowing picked bodies to be secured against the pipette body mounts without interference between the pipette body clamping plate and the unpicked array of bodies. Once the picked bodies have been raised above the unpicked array by the pipetting head, the picked bodies can then be fully clamped in place by moving the pipette body clamping plate 125 to the clamping position.

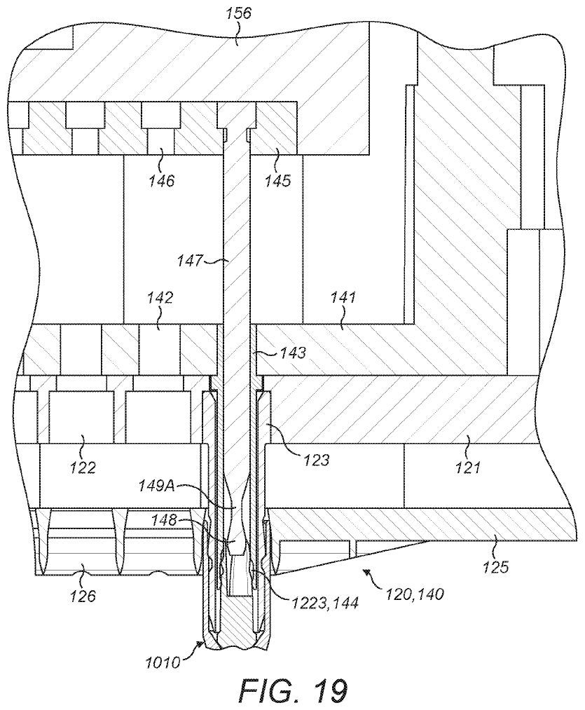

Step 3 is discussed with reference to FIG. 19. In step 3, the entire plunger mounting assembly 140 is lowered using the dispense drive actuator. This brings the plunger mount sleeves 143 into contact with the plunger connector portion 1203 at the upper, or proximal, ends of the plunger 1200. Further downward movement of the plunger mounting assembly 140 causes the inner surface of the plunger mount sleeve 143 to ride over the outer surface of the plunger connector portion, inwardly deflecting the plunger connector portion to the contracted or compressed position and allowing the bulbous head 1223 at the top of the plunger 1200 to be received in the groove 144 on the inside surface of the plunger mount sleeve 143. Once the bulbous head 1223 is received in the groove 144 on the inside surface of the plunger mount sleeve 143, as shown in FIG. 19, the flexible segments 1221 of the plunger connector portion 1203 return to an undeflected, or partially deflected state. In this position, the plunger connector portion is in a rest state and each plunger 1200 is coupled to its respective plunger mount sleeve 143 in a snap fit connection.

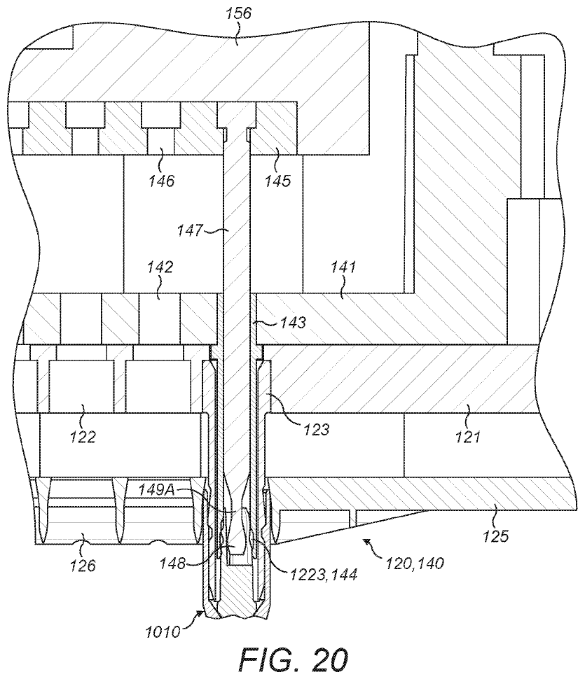

Step 4 is discussed with reference to FIG. 20. In step 4, the plunger clamping plate 145 is moved in the axial direction towards the plunger mounting plate 141 by the plunger clamp drive mechanism until the heads 148 of the plunger clamp rods are adjacent to the snap fit connection between the plunger and the plunger mount sleeve. The outer diameter of the head 148 of each clamping rod is greater than the inner diameter of the plunger when in the contracted state, or “second inner diameter”. For example, it may be substantially the same as the inner diameter of the un-deflected plunger, or “first” inner diameter. With this arrangement, the plunger connector portion is prevented from contracting fully to the contracted position, thus preventing the bulbous head 1223 of the plunger 1200 from being released from the groove 144 on the inner surface of the plunger mount sleeve 143. In this manner, the plunger 1200 is “locked” or “clamped” in position without the need to exert any significant compressive forces on the plunger connector portion. This can reduce the force required to engage the plunger clamping mechanism.

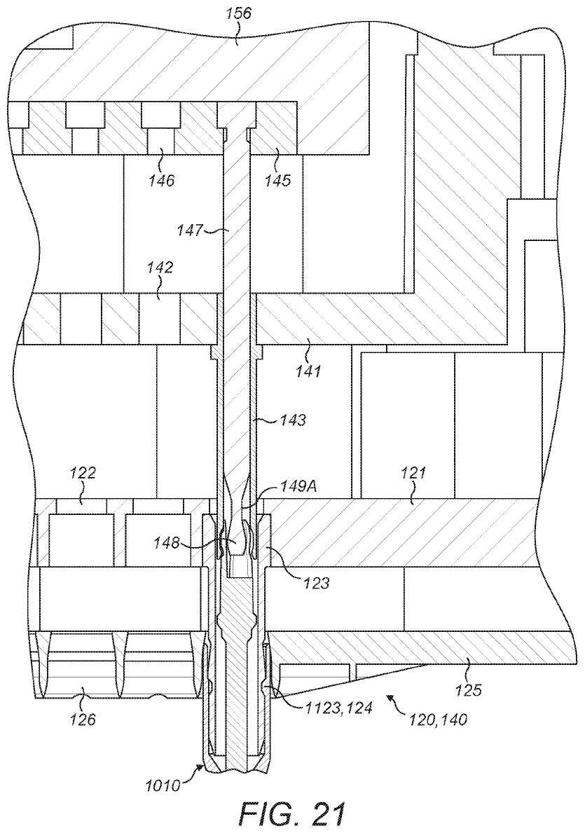

To perform an aspirating operation, the pipetting head 100 is moved to the desired position relative to a set of liquid samples using the pipetting head Z motor. The plunger of each pipette is then raised within its respective pipette body using the direct drive actuator to move the entire plunger mounting assembly 140 away from the pipette body mounting mechanism 120, as shown in FIG. 21, to draw fluid into the pipette body. The fluid can then be dispensed as desired by moving the plunger clamping mechanism in the opposite direction using the dispense drive actuator assembly.

Once the aspirating and dispensing operations are complete, the pipette or pipettes can be ejected as follows. Firstly, the plungers are each moved to the bottom of their travel inside their respective pipette body and the pipette body clamping mechanism 130 is disengaged by moving the pipette body clamping plate 125 towards the pipette body mounting plate 121 to bring the clamp sleeves 127 out of alignment with the snap-fit connection between each pipette body and its respective pipette body mount 123, and away from the outer surfaces of the pipette bodies. Next the plunger clamping plate 145 is moved towards the plunger mounting plate 141, beyond the engaged position, such that the head 148 of each clamping rod 147 is moved out of alignment with the snap-fit connection between each plunger 1200 and its respective plunger mount 143 and instead bringing the neck portion 149A of each clamping rod 147 into alignment with the snap-fit connection and causing the distal end surface of the head of the clamping rod to abut against the internal wall 1224 of the plunger connector portion 1203. Since the neck portions 149A of the clamping rods 147 have an outer diameter which is less than the second, compressed, inner diameter of the plunger connector portions 1203, when the clamping rods are in this position, the plunger connector portions are not restricted from deflecting inwardly to the compressed state. Thus, continued downward movement of the plunger clamping plate 145 releases the bulbous heads 1223 of the plunger connector portions 1203 from the corresponding radially extending features 144 of the plunger mounts 143 to remove the plungers 1200 from the pipetting head. Further downward movement of the plunger clamping plate, and therefore of the clamping rods and the plungers themselves, pushes the distal end portions of the plungers against the respective portions of the pipette bodies within which they are located. In this manner, the plungers and the plunger clamping mechanism can be used to release the pipette bodies 1100 from the pipette body mounts 123, thereby ejecting the pipettes 1010 from the pipetting head.

Although the invention has been described above with reference to one or more preferred embodiments, it will be appreciated that various changes or modifications may be made without departing from the scope of the invention as defined in the appended claims.

The present invention may also be described or defined in accordance with the following clauses:
1. A pipetting head for a liquid dispensing apparatus for use with an array of pipettes, each having a pipette body and a plunger disposed within the pipette body, the pipetting head comprising:
   a pipetting head chassis;
   a pipette body mounting assembly for holding the pipette bodies;
   a plunger mounting assembly for holding the plungers;
   a dispense drive actuator assembly operable to move the plunger mounting assembly relative to the pipette body mounting assembly along a drive axis to perform a dispensing or aspirating operation, the dispense drive actuator assembly comprising a dispense drive motor and a dispense drive mechanism by which the dispense drive motor is coupled to the plunger mounting assembly to drive axial displacement thereof; and
   a pipette body clamping mechanism operable to selectively clamp the pipette bodies of the array of pipettes to the pipette body mounting assembly, the pipette body clamping mechanism comprising:
      a pipette body clamping plate positioned below the plunger mounting assembly;
      a plurality of pipette body clamping members on the pipette body clamping plate; and
      a pipette body clamp drive mechanism operable to selectively engage the pipette body clamping mechanism, the pipette body clamp drive mechanism having a linear actuator and a pipette body clamp drive linkage by which the linear actuator is coupled to the pipette body clamping plate, wherein the pipette body clamp drive linkage comprises at least one standoff fixed in relation to the pipette body clamping plate and extending axially between the pipette body clamping plate and the linear actuator, and wherein the linear actuator is configured to move the at least one standoff relative to the pipetting head chassis in the axial direction to selectively engage the pipette body clamping mechanism.
2. The pipetting head of clause 1, wherein the at least one standoff comprises a plurality of standoffs, each connected to a periphery of the pipette body clamping plate.
3. The pipetting head of clause 1 or clause 2, wherein the at least one standoff comprises at least one guide rod along which the plunger mounting assembly is slidably supported when axially displaced by the dispense drive actuator assembly.
4. The pipetting head of any preceding clause, wherein the at least one standoff is slidably supported by the pipetting head chassis.
5. The pipetting head of any preceding clause, wherein the linear actuator is located above the plunger mounting assembly.
6. The pipetting head of any preceding clause, wherein the linear actuator comprises a pipette body clamp motor and a screw mechanism for converting rotational movement of the pipette body clamp motor into axial movement of the at least one standoff.
7. The pipetting head of clause 6, wherein the screw mechanism is hollow and defines an axial bore through which the dispense drive mechanism extends.
8. The pipetting head of clause 7, wherein the dispense drive mechanism and the screw mechanism are concentric.
9. The pipetting head of clause 7 or clause 8, wherein the screw mechanism comprises first and second sleeves which are concentric and coupled by a threaded connection, wherein the pipette body clamp motor is configured to rotate the first sleeve about the second sleeve to drive axial movement of the at least one standoff.
10. The pipetting head of clause 9, wherein the threaded connection has a pitch diameter of less than 30 percent of the width of the pipette body clamping plate.
11. The pipetting head of any of clauses 6 to 10, wherein the pipette body clamp motor is coupled to the screw mechanism by one or more gears.
12. The pipetting head of any of clauses 6 to 11, where the pipette body clamp motor is fixed in relation to the pipetting head chassis.
13. The pipetting head of any preceding clause, further comprising a plunger clamping mechanism which is operable to clamp the plungers of the array of pipettes to the plunger mounting assembly, the plunger clamping mechanism comprising:
   a plunger clamping plate;
   a plurality of plunger clamping members on the plunger clamping plate; and
   a plunger clamp drive mechanism operable to selectively engage the plunger clamping mechanism, the plunger clamping mechanism having a linear actuator configured to drive relative axial movement between the plunger clamping plate and the plunger mounting assembly to selectively engage the plunger clamping mechanism.
14. The pipetting head of clause 13, wherein the linear actuator of the plunger clamp drive mechanism comprises a plunger clamp motor and a screw mechanism for converting rotational movement of the plunger clamp motor into axial movement of the plunger clamping plate.
15. The pipetting head of clause 14, wherein the screw mechanism of the plunger clamp drive mechanism comprises first and second sleeves which are concentric and coupled by a threaded connection, wherein the second sleeve is fixed in relation to the plunger mounting assembly and wherein the plunger clamp motor is configured to rotate the first sleeve about the second sleeve to drive axial movement of the plunger clamping plate.
16. The pipetting head of clause 15, wherein the threaded connection has a pitch diameter of less than 30 percent of the width of the plunger clamping plate.
17. The pipetting head of any of clauses 14 to 16, wherein the screw mechanism of the plunger clamp drive mechanism is hollow and defines an axial bore in which part of the dispense drive mechanism is received.
18. The pipetting head of clause 17, wherein the dispense drive mechanism comprises a ball screw actuator nut which is at least partly housed within the axial bore of the screw mechanism of the plunger clamp drive mechanism.
19. The pipetting head of clause 17 or clause 18, wherein the dispense drive mechanism and the screw mechanism of the plunger clamp drive mechanism are concentric.
20. The pipetting head of any of clauses 13 to 19, wherein the plunger mounting assembly comprises a plurality of plunger mounts, and wherein the plurality of plunger clamping members comprises a plurality of clamping rods which are each coaxial with one of the plurality of plunger mounts and extend within that plunger mount to restrict inward movement of a plunger received in that plunger mount when the plunger clamping mechanism is engaged.
21. The pipetting head of clause 20, wherein the plunger mounting assembly further comprises a plunger mounting plate on which the plurality of plunger mounts is provided.
22. A liquid dispensing apparatus comprising:
   a main body with a deck for receiving one or more microplates; and
   a pipetting head according to any of clauses 1 to 21, the pipetting head being positioned above the deck.
23. A pipetting head for a liquid dispensing apparatus for use with an array of pipettes, each having a pipette body and a plunger disposed within the pipette body, the pipetting head comprising:
   a pipetting head chassis;
   a pipette body mounting assembly for holding the pipette bodies;
   a plunger mounting assembly for holding the plungers;
   a dispense drive actuator assembly operable to move the plunger mounting assembly relative to the pipette body mounting assembly along a drive axis to perform a dispensing or aspirating operation, the dispense drive actuator assembly comprising a dispense drive motor and a dispense drive mechanism by which the dispense drive motor is coupled to the plunger mounting assembly to drive axial displacement thereof; and
   a plunger clamping mechanism which is operable to clamp the plungers of the array of pipettes to the plunger mounting assembly, the plunger clamping mechanism comprising:
      a plunger clamping plate;
      a plurality of plunger clamping members on the plunger clamping plate; and
      a plunger clamp drive mechanism operable to selectively engage the plunger clamping mechanism, the plunger clamping mechanism having a linear actuator configured to drive relative axial movement between the plunger clamping plate and the plunger mounting assembly to selectively engage the plunger clamping mechanism.
24. The pipetting head of clause 23, wherein the linear actuator of the plunger clamp drive mechanism comprises a plunger clamp motor and a screw mechanism for converting rotational movement of the plunger clamp motor into axial movement of the plunger clamping plate.
25. The pipetting head of clause 24, wherein the screw mechanism of the plunger clamp drive mechanism comprises first and second sleeves which are concentric and coupled by a threaded connection, wherein the second sleeve is fixed in relation to the plunger mounting assembly and wherein the plunger clamp motor is configured to rotate the first sleeve about the second sleeve to drive axial movement of the plunger clamping plate.
26. The pipetting head of clause 25, wherein the threaded connection has a pitch diameter of less than 30 percent of the width of the plunger clamping plate.
27. The pipetting head of any of clauses 24 to 26, wherein the screw mechanism of the plunger clamp drive mechanism is hollow and defines an axial bore in which part of the dispense drive mechanism is received.
28. The pipetting head of clause 27, wherein the dispense drive mechanism comprises a ball screw actuator nut which is at least partly housed within the axial bore of the screw mechanism of the plunger clamp drive mechanism.
29. The pipetting head of clause 27 or clause 28, wherein the dispense drive mechanism and the screw mechanism of the plunger clamp drive mechanism are concentric.
30. The pipetting head of any of clauses 23 to 29, wherein the plunger mounting assembly comprises a plurality of plunger mounts, and wherein the plurality of plunger clamping members comprises a plurality of clamping rods which are each coaxial with one of the plurality of plunger mounts and extend within that plunger mount to restrict inward movement of a plunger received in that plunger mount when the plunger clamping mechanism is engaged.
31. The pipetting head of clause 30, wherein the plunger mounting assembly further comprises a plunger mounting plate on which the plurality of plunger mounts is provided.

What is claimed is:

1. A pipetting head for a liquid dispensing apparatus for use with an array of removable pipettes, each having a pipette body and a plunger disposed within the pipette body, the pipetting head comprising:
a pipetting head chassis:
a pipette body mounting assembly for holding the pipette bodies of the array of removable pipettes:
a plunger mounting assembly for holding the plungers of the array of removable pipettes:
a dispense drive actuator assembly operable to move the plunger mounting assembly relative to the pipette body mounting assembly along a drive axis to perform a dispensing or aspirating operation, the dispense drive actuator assembly comprising a dispense drive motor and a dispense drive mechanism by which the dispense drive motor is coupled to the plunger mounting assembly to drive axial displacement thereof: and a pipette body clamping mechanism operable to selectively clamp the pipette bodies of the array of pipettes to the pipette body mounting assembly, the pipette body clamping mechanism comprising:
a pipette body clamping plate positioned below the plunger mounting assembly:
a plurality of pipette body clamping members on the pipette body clamping plate: and
a pipette body clamp drive mechanism operable to selectively engage the pipette body clamping mechanism, the pipette body clamp drive mechanism having a linear actuator and a pipette body clamp drive linkage by which the linear actuator is coupled to the pipette body clamping plate, wherein the pipette body clamp drive linkage comprises at least one standoff fixed in relation to the pipette body clamping plate and extending axially between the pipette body clamping plate and the linear actuator, and wherein the linear actuator is configured to move the at least one standoff relative to the pipetting head chassis in the axial direction to selectively engage the pipette body clamping mechanism.

2. The pipetting head of claim 1, wherein the at least one standoff comprises a plurality of standoffs, each connected to a periphery of the pipette body clamping plate.

3. The pipetting head of claim 1, wherein the at least one standoff comprises at least one guide rod along which the plunger mounting assembly is slidably supported when axially displaced by the dispense drive actuator assembly.

4. The pipetting head of claim 1, wherein the at least one standoff is slidably supported by the pipetting head chassis.

5. The pipetting head of claim 1, wherein the linear actuator is located above the plunger mounting assembly.

6. The pipetting head of claim 1, wherein the linear actuator comprises a pipette body clamp motor and a screw mechanism for converting rotational movement of the pipette body clamp motor into axial movement of the at least one standoff.

7. The pipetting head of claim 6, wherein the screw mechanism is hollow and defines an axial bore through which the dispense drive mechanism extends.

8. The pipetting head of claim 7, wherein the dispense drive mechanism and the screw mechanism are concentric.

9. The pipetting head of claim 7, wherein the screw mechanism comprises first and second sleeves which are concentric and coupled by a threaded connection, wherein the pipette body clamp motor is configured to rotate the first sleeve about the second sleeve to drive axial movement of the at least one standoff.

10. The pipetting head of claim 9, wherein the threaded connection has a pitch diameter of less than 30 percent of the width of the pipette body clamping plate.

11. The pipetting head of claim 6, wherein the pipette body clamp motor is coupled to the screw mechanism by one or more gears.

12. The pipetting head of claim 6, where the pipette body clamp motor is fixed in relation to the pipetting head chassis.

13. The pipetting head of claim 1, further comprising a plunger clamping mechanism which is operable to clamp the plungers of the array of pipettes to the plunger mounting assembly, the plunger clamping mechanism comprising:
a plunger clamping plate:
a plurality of plunger clamping members on the plunger clamping plate; and
a plunger clamp drive mechanism operable to selectively engage the plunger clamping mechanism, the plunger clamping mechanism having a linear actuator configured to drive relative axial movement between the plunger clamping plate and the plunger mounting assembly to selectively engage the plunger clamping mechanism.

14. The pipetting head of claim 13, wherein the linear actuator of the plunger clamp drive mechanism comprises a plunger clamp motor and a screw mechanism for converting rotational movement of the plunger clamp motor into axial movement of the plunger clamping plate.

15. The pipetting head of claim 14, wherein the screw mechanism of the plunger clamp drive mechanism comprises first and second sleeves which are concentric and coupled by a threaded connection, wherein the second sleeve is fixed in relation to the plunger mounting assembly and wherein the plunger clamp motor is configured to rotate the first sleeve about the second sleeve to drive axial movement of the plunger clamping plate.

16. The pipetting head of claim 15, wherein the threaded connection has a pitch diameter of less than 30 percent of the width of the plunger clamping plate.

17. The pipetting head of claim 14, wherein the screw mechanism of the plunger clamp drive mechanism is hollow and defines an axial bore in which part of the dispense drive mechanism is received.

18. The pipetting head of claim 17, wherein the dispense drive mechanism comprises a ball screw actuator nut which is at least partly housed within the axial bore of the screw mechanism of the plunger clamp drive mechanism.

19. The pipetting head of claim 17, wherein the dispense drive mechanism and the screw mechanism of the plunger clamp drive mechanism are concentric.

20. The pipetting head of claim 13, wherein the plunger mounting assembly comprises a plurality of plunger mounts, and wherein the plurality of plunger clamping members comprises a plurality of clamping rods which are each coaxial with one of the plurality of plunger mounts and extend within that plunger mount to restrict inward movement of a plunger received in that plunger mount when the plunger clamping mechanism is engaged.

21. The pipetting head of claim 20, wherein the plunger mounting assembly further comprises a plunger mounting plate on which the plurality of plunger mounts is provided.

22. A liquid dispensing apparatus comprising:
a main body with a deck for receiving one or more microplates: and
a pipetting head according to claim 1, the pipetting head being positioned above the deck.
